(19) United States
(12) Patent Application Publication
(10) Pub. No.: US 2026/0354542 A1
(43) Pub. Date: Nov. 12, 2026

(54) ZIPPER STOPPER AND METHOD OF USE

(71) Applicant: EVERNEST LLC, Lafayette, CO (US)

(72) Inventors: Caitlin HURST, Lafayette, CO (US); Philip POWERS, Lafayette, CO (US)

(21) Appl. No.: 19/515,029

(22) PCT Filed: Aug. 23, 2024
(86) PCT No.: PCT/US2024/043660

§ 371 Date: Feb. 27, 2026

Related U.S. Application Data
(60) Provisional application No. 63/579,350, filed on Aug. 29, 2023.

(51) Int. Cl. A44B 19/36; F16B 2/12

(52) U.S. Cl. CPC A44B 19/36; F16B 2/12

(57) ABSTRACT

A zipper stopper includes a pair of opposing jaws including at least a first jaw and a second jaw opposing the first jaw, with the first jaw and the second jaw being movable between an engaged position and a disengaged position. A locking mechanism secures the first jaw and the second jaw in the engaged position. The locking mechanism includes a shaft extending at least partially through at least one of the first jaw and the second jaw, a handle mechanism coupled to the shaft. The handle mechanism translates the shaft in a lateral direction such that the shaft contacts at least one of the first jaw and the second jaw in the engaged position.

### CROSS-REFERENCE TO RELATED APPLICATION

This application claims priority to and the benefit of U.S. Prov. App. No. 63/579,350, filed Aug. 29, 2023, entitled “ZIPPER STOPPER AND METHOD OF USE,” which is incorporated herein by reference in its entirety.

### FIELD OF THE DISCLOSURE

Embodiments described herein are related to clothing garments, bags, and other articles which are constructed with interlocking zipper tapes and zipper sliders; more particularly, this invention relates those situations where the user wishes to prevent the zipper slider from moving or sliding such that the interlocking zipper tapes are prevented from disengaging from one another.

### BACKGROUND

There are a variety of locking zipper designs, however they typically require that the zipper slider be purpose-built such that the zipper slider may be locked in place. If a user wishes to apply a similar locking or stopping functionality to a conventional zipper which lacks a locking mechanism, the user is currently unable to do so.

Locking zippers are generally more mechanically complicated than a conventional non-locking zipper. Because locking zippers are generally more complicated, they are generally more expensive and difficult to manufacture. The added layer of complexity causes manufacturers which produce articles having zippers to be less inclined to incorporate a locking zipper in their design. In addition, some consumers may not want a locking zipper, so a manufacturer or designer may error on the side of not providing a locking zipper. Furthermore, if a user is unaware that their zippered article is configured with a locking zipper, they may become confused or frustrated when the zipper does not slide freely in the way the user expects. To reduce user confusion or frustration, the manufacturer or designer may error on the side of not providing a locking zipper.

For the reasons described above, there is a present need for a zipper stopper which may be applied to a conventional zipper assembly which prevents or inhibits the movement or disengagement of the zipper.

### SUMMARY OF THE DISCLOSURE

In embodiments, a zipper stopper is disclosed. The zipper stopper includes a pair of opposing jaws including at least a first jaw and a second jaw opposing the first jaw, with the first jaw and the second jaw being movable between an engaged position and a disengaged position. A locking mechanism secures the first jaw and the second jaw in the engaged position. The locking mechanism includes a shaft extending at least partially through at least one of the first jaw and the second jaw, a handle mechanism coupled to the shaft. The handle mechanism translates the shaft in a lateral direction such that the shaft contacts at least one of the first jaw and the second jaw in the engaged position.

In another embodiment, a zipper slider locking system is disclosed. The zipper slider locking system includes a zipper chain, a zipper slider coupled to the zipper chain, such that the zipper slider is configured to translate along the zipper chain in a longitudinal direction, and a zipper stopper releasably secured about the zipper chain. The zipper stopper includes a pair of opposing jaws including at least a first jaw and a second jaw opposing the first jaw, the first jaw and the second jaw being movable between an engaged position and a disengaged position, and a locking mechanism configured to secure the first jaw and the second jaw in the engaged position. The locking mechanism includes a shaft extending at least partially through at least one of the first jaw and the second jaw and a handle mechanism coupled to the shaft. The handle mechanism is configured to translate the shaft in a lateral direction such that the shaft contacts at least one of the first jaw and the second jaw in the engaged position, and the zipper stopper limits translation of the zipper slider in the longitudinal direction when the first jaw and the second jaw are in the engaged position.

In yet another embodiment, a method of locking a zipper slider is disclosed. The method includes translating the zipper slider to a desired location along a zipper chain; positioning a first jaw and a second jaw of a zipper stopper in a disengaged position, such that the first jaw is released from the second jaw; positioning the first jaw and the second jaw of the zipper stopper about the zipper chain adjacent the zipper slider; engaging the first jaw and the second jaw of the zipper stopper, such that the first jaw and the second jaw are moved to an engaged position; and releasably securing the first jaw to the second jaw using a locking mechanism of the zipper stopper.

These aspects and other advantages and features are apparent from the following description taken in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 shows an isometric view of the zipper stopper in accordance with a first illustrated embodiment;

FIG. 2 shows a front view of the zipper stopper in accordance with a first illustrated embodiment;

FIG. 2A shows a sectional side view of the zipper stopper in accordance with a first illustrated embodiment;

FIG. 3 shows a partially exploded isometric view of the zipper stopper in accordance with a first illustrated embodiment;

FIG. 4 shows an isometric view of the zipper stopper engaged to a zipper chain in accordance with a first illustrated embodiment;

FIG. 5 shows an isometric view of the zipper stopper in accordance with a second illustrated embodiment;

FIG. 6 shows a front view of the zipper stopper in accordance with a second illustrated embodiment;

FIG. 6A shows a sectional side view of the zipper stopper in accordance with a second illustrated embodiment;

FIG. 7 shows a partially exploded isometric view of the zipper stopper in accordance with a second illustrated embodiment;

FIG. 8 shows an isometric view of the zipper stopper engaged to a zipper chain in accordance with a second illustrated embodiment;

FIG. 9 shows an isometric view of the zipper stopper in accordance with a third illustrated embodiment;

FIG. 10 shows a front view of the zipper stopper engaged to a zipper chain in accordance with a third illustrated embodiment;

FIG. 11 shows a front view of the zipper stopper disengaged from a zipper chain in accordance with a third illustrated embodiment;

FIG. 12 shows an isometric view of the zipper stopper engaged to a zipper chain in accordance with a third illustrated embodiment;

FIG. 13 shows an isometric view of the zipper stopper in accordance with a fourth illustrated embodiment;

FIG. 14 shows a front view of the zipper stopper in accordance with a fourth illustrated embodiment;

FIG. 14A shows a sectional top view of the zipper stopper in accordance with a fourth illustrated embodiment;

FIG. 15 shows a partially exploded side view of the zipper stopper in accordance with a fourth illustrated embodiment;

FIG. 16 shows a top view of the zipper stopper in an engaged and disengaged position in accordance with a fourth illustrated embodiment;

FIG. 17 shows a partially exploded isometric view of the zipper stopper m accordance with a fourth illustrated embodiment;

FIG. 18 shows an isometric view of the zipper stopper engaged to a zipper chain in accordance with a fourth illustrated embodiment;

FIG. 19 shows an isometric view of the zipper stopper in accordance with a fifth illustrated embodiment;

FIG. 20 shows an isometric view of the zipper stopper in a disengaged position in accordance with a fifth illustrated embodiment;

FIG. 21 shows a front view of the zipper stopper in accordance with a fifth illustrated embodiment;

FIG. 22 shows a front view of the zipper stopper in a disengaged position in accordance with a fifth illustrated embodiment;

FIG. 23 shows a front view of the zipper stopper in an engaged and disengaged position in accordance with a fifth illustrated embodiment;

FIG. 24 shows an isometric view of the zipper stopper engaged to a zipper chain in accordance with a fifth illustrated embodiment;

FIG. 25 shows an isometric view of the zipper stopper in accordance with a sixth illustrated embodiment;

FIG. 26 shows a front view of the zipper stopper in accordance with a sixth illustrated embodiment;

FIG. 26A shows a sectional top view of the zipper stopper in accordance with a sixth illustrated embodiment;

FIG. 27 shows an isometric cut-away view of the zipper stopper in accordance with a sixth illustrated embodiment;

FIG. 28 shows a top view of the zipper stopper in an engaged and disengaged position in accordance with a sixth illustrated embodiment;

FIG. 29 shows an isometric view of the zipper stopper engaged to a zipper chain in accordance with a sixth illustrated embodiment;

FIG. 30 shows an isometric view of the zipper stopper in accordance with a seventh illustrated embodiment;

FIG. 31 shows a front view of the zipper stopper in accordance with a seventh illustrated embodiment;

FIG. 31A shows a sectional side view of the zipper stopper in accordance with a seventh illustrated embodiment;

FIG. 32 shows a partially exploded isometric view of the zipper stopper m accordance with a seventh illustrated embodiment;

FIG. 33 shows a partially exploded top view of the zipper stopper in accordance with a seventh illustrated embodiment;

FIG. 34 shows a partially exploded front view of the zipper stopper in accordance with a seventh illustrated embodiment;

FIG. 35 shows an isometric view of the zipper stopper engaged to a zipper chain in accordance with a seventh illustrated embodiment;

FIG. 36 shows an isometric view of the zipper stopper in accordance with an eighth illustrated embodiment;

FIG. 37 shows a top view of the zipper stopper in accordance with an eighth illustrated embodiment;

FIG. 38 shows a top view of the zipper stopper in accordance with an eighth illustrated embodiment;

FIG. 39 shows a front view of the zipper stopper in accordance with an eighth illustrated embodiment;

FIG. 40 shows an exploded isometric view of the zipper stopper in accordance with an eighth illustrated embodiment;

FIG. 41 shows an isometric view of the zipper stopper engaged with a zipper chain in accordance with an eighth illustrated embodiment;

FIG. 42 shows an isometric view of the zipper stopper in accordance with a ninth illustrated embodiment;

FIG. 43 shows an isometric view of the zipper stopper engaged with a zipper chain in accordance with a ninth illustrated embodiment;

FIG. 44 shows an isometric view of the zipper stopper in accordance with a tenth illustrated embodiment;

FIG. 45 shows a front view of the zipper stopper in accordance with a tenth illustrated embodiment;

FIG. 45A shows a sectional top view of the zipper stopper in accordance with a tenth illustrated embodiment;

FIG. 46 shows a front view of the zipper stopper in accordance with a tenth illustrated embodiment;

FIG. 46A shows a sectional top view of the zipper stopper in accordance with a tenth illustrated embodiment;

FIG. 47 shows an isometric view of the zipper stopper in accordance with a tenth illustrated embodiment;

FIG. 48 shows an isometric view of the zipper stopper in accordance with a tenth illustrated embodiment;

FIG. 49 shows an exploded isometric view of the zipper stopper in accordance with a tenth illustrated embodiment;

FIG. 50 shows an isometric view of the zipper stopper engaged to a zipper chain in accordance with a tenth illustrated embodiment;

FIG. 51 shows an isometric view of the zipper stopper in accordance with a eleventh illustrated embodiment;

FIG. 52 shows a top view of the zipper stopper in accordance with a eleventh illustrated embodiment;

FIG. 52A shows a detail view of the zipper stopper in accordance with a eleventh illustrated embodiment;

FIG. 53 shows a top view of the zipper stopper in accordance with a eleventh illustrated embodiment;

FIG. 54 shows a front view of the zipper stopper in accordance with a eleventh illustrated embodiment;

FIG. 54A shows a sectional top view of the zipper stopper in accordance with a eleventh illustrated embodiment;

FIG. 55 shows a front view of the zipper stopper in accordance with a eleventh illustrated embodiment;

FIG. SSA shows a sectional top view of the zipper stopper in accordance with a eleventh illustrated embodiment;

FIG. 56 shows an exploded isometric view of the zipper stopper in accordance with a eleventh illustrated embodiment;

FIG. 57 shows an isometric view of the zipper stopper engaged to a zipper chain in accordance with a eleventh illustrated embodiment;

FIG. 58 shows an isometric view of the zipper stopper in accordance with a twelfth illustrated embodiment;

FIG. 59 shows a front view of the zipper stopper in accordance with a twelfth illustrated embodiment;

FIG. 59A shows a sectional side view of the zipper stopper in accordance with a twelfth illustrated embodiment;

FIG. 60 shows an exploded isometric view of the zipper stopper in accordance with a twelfth illustrated embodiment;

FIG. 61 shows a top view of the zipper stopper in accordance with a twelfth illustrated embodiment;

FIG. 62 shows a front view of the zipper stopper in accordance with a twelfth illustrated embodiment;

FIG. 63 shows an isometric view of the zipper stopper engaged to a zipper chain in accordance with a twelfth illustrated embodiment;

FIG. 64 shows an isometric view of the zipper stopper in accordance with a thirteenth illustrated embodiment;

FIG. 65 shows a top view of the zipper stopper in accordance with a thirteenth illustrated embodiment;

FIG. 66 shows a front view of the zipper stopper in accordance with a thirteenth illustrated embodiment;

FIG. 67 shows an isometric view of the zipper stopper in accordance with a thirteenth illustrated embodiment;

FIG. 68 shows an isometric view of the zipper stopper engaged to a zipper chain in accordance with a thirteenth illustrated embodiment;

FIG. 69 shows an isometric view of the zipper stopper in accordance with a thirteenth illustrated embodiment;

FIG. 70 shows a front view of the zipper stopper in accordance with a fourteenth illustrated embodiment;

FIG. 70A shows a sectional side view of the zipper stopper in accordance with a fourteenth illustrated embodiment;

FIG. 70B shows a sectional detail view of the zipper stopper in accordance with a fourteenth illustrated embodiment;

FIG. 70C shows a sectional detail view of the zipper stopper in accordance with a fourteenth illustrated embodiment;

FIG. 71 shows an exploded isometric view of the zipper stopper in accordance with a fourteenth illustrated embodiment;

FIG. 72 shows an exploded front view of the zipper stopper in accordance with a fourteenth illustrated embodiment;

FIG. 72A shows a sectional side view of the zipper stopper in accordance with a fourteenth illustrated embodiment;

FIG. 73 shows an exploded isometric view of the zipper stopper in accordance with a fourteenth illustrated embodiment;

FIG. 74 shows an isometric view of the zipper stopper engaged to a zipper chain in accordance with a fourteenth illustrated embodiment;

FIG. 75 shows an isometric view of the zipper stopper in accordance with a fifteenth illustrated embodiment;

FIG. 76 shows a sectional side view of the zipper stopper in accordance with a fifteenth illustrated embodiment;

FIG. 76A shows a sectional detail side view of the zipper stopper in accordance with a fifteenth illustrated embodiment;

FIG. 77 shows an exploded side view of the zipper stopper in accordance with a fifteenth illustrated embodiment;

FIG. 77A shows a sectional side view of the zipper stopper in accordance with a fifteenth illustrated embodiment;

FIG. 78 shows a sectional front view of the zipper stopper in accordance with a fifteenth illustrated embodiment;

FIG. 79 shows an isometric view of the zipper stopper in accordance with a sixteenth illustrated embodiment;

FIG. 80 shows a front view of the zipper stopper in accordance with a sixteenth illustrated embodiment;

FIG. 80A shows a sectional side view of the zipper stopper in accordance with a sixteenth illustrated embodiment;

FIG. 81 shows an exploded front view of the zipper stopper in accordance with a sixteenth illustrated embodiment;

FIG. 81A shows a sectional side view of the zipper stopper in accordance with a sixteenth illustrated embodiment;

FIG. 82 shows a sectional front view of the zipper stopper in accordance with a sixteenth illustrated embodiment;

FIG. 83 shows a front view of the zipper stopper in accordance with a seventeenth illustrated embodiment;

FIG. 83A shows a sectional side view of the zipper stopper in accordance with a seventeenth illustrated embodiment;

FIG. 84 shows an isometric view of the zipper stopper in accordance with a seventeenth illustrated embodiment;

FIG. 85 shows an isometric view of the zipper stopper in accordance with a seventeenth illustrated embodiment;

FIG. 86 shows an isometric view of the zipper stopper in accordance with a seventeenth illustrated embodiment;

FIG. 87 shows a front view of the zipper stopper in accordance with a seventeenth illustrated embodiment;

FIG. 87A shows a sectional top view of the zipper stopper in accordance with a seventeenth illustrated embodiment;

FIG. 88 shows a front view of the zipper stopper in accordance with a seventeenth illustrated embodiment; and

FIG. 88A shows a sectional top view of the zipper stopper in accordance with a seventeenth illustrated embodiment;

### DETAILED DESCRIPTION

For purposes of explanation and not limitation, details and descriptions of certain preferred embodiments are hereinafter provided such that one having ordinary skill in the art may be enabled to make and use the invention. These details and descriptions are representative only of certain preferred embodiments, however, a myriad of other embodiments which will not be expressly described will be readily understood by one having skill in the art upon a thorough review of the instant disclosure. Accordingly, any reviewer of the instant disclosure should interpret the scope of the invention only by the claims, as such scope is not intended to be limited by the embodiments described and illustrated herein.

For purposes herein, the term “zipper tape” refers to a single set of aligned teeth elements as well as the material to which the set of aligned teeth elements are attached.

The term “teeth elements” refers to the aligned interlocking elements which make up the inner side of each zipper tape which, when interlocked form a zipper chain.

The term “zipper chain” refers to a set of interlocked zipper tapes.

The term “zipper slider” refers to the zipper component which the user may slide along the length of the zipper tapes which interlocks or separates the teeth elements depending on which direction the slider is moved.

The term “zipper pull tab” refers to the component of a zipper that the user is intended to grip such that the user may move the zipper slider along the zipper tape.

The term “zipper” refers to the zipper tape, teeth elements, zipper chain, zipper slider, zipper pull tab, or some combination thereof.

The term “jaws” or “set of jaws” refers to at least two opposing surfaces, structures, or geometric shapes which may be engaged towards each other to hold objects or material between the jaws. A set of jaws may take the form of one continuous body or multiple bodies.

The term “actuatable structure” refers to the zipper stopper mechanism or structure which enables the engagement and/or disengagement, of the zipper stopper jaws, chain engagement feature, or the zipper slider engagement feature.

The term “elastic material” refers a material that generally returns to its at-rest shape after being deformed.

The term “spinning element” refers to a feature which may be spun by the user or a fitting which the user may use a tool to spin. This term is meant to include handles, knobs, dials, levers, and elements which serve a similar function, as well as drive recesses such as a “Phillips” bit recess, drive protrusions such as square rod-end, and elements which serve a similar function, that would enable the user to spin the spinning element.

The term “stopper lock feature” refers to a mechanism which may be engaged to hold the jaws of the zipper stopper in the engaged or disengaged positions, depending on the embodiment.

The term “keeper attachment feature” refers to a mechanism which may be used to temporarily attach the zipper stopper to an article of fabric or other object to keep the zipper stopper readily available to the user.

The term “garment” typically refers to an article of clothing, but may also be used to mean a bag or any other article to which a zipper is affixed.

Unless explicitly defined herein, terms are to be construed in accordance with the plain and ordinary meaning as would be appreciated by one having skill in the art.

In the embodiments described herein, the zipper stopper may have two or more opposing jaws which are coupled to each other by an actuatable, or movable, structure which allows one or more jaws to be reversibly engaged towards the opposing jaw or jaws. In most embodiments, these jaws are engaged around the zipper slider or zipper chain. To apply the zipper stopper, the opposing jaws are disengaged, or opened, if not already disengaged. The disengaged jaws are then placed around the zipper slider or the zipper chain. The opposing jaws are then engaged toward each other. The jaws are not required to be in direct, collinear, opposition to each other.

By engaging the opposing jaws, the jaws may apply a compressive force around the zipper slider, the zipper chain, the material to which the zipper tapes are attached to. In some embodiments, the compressive force may be transmitted to any combination of the zipper slider, the zipper chain, and/or the fabric to which the zipper tape is attached. In some embodiments, the compressive force may be transmitted to the left and right sides of the zipper chain alone, holding the two zipper tapes together. In some embodiments, the compressive force may pinch the fabric behind the zipper chain such that the compressive force is not transmitted to the zipper slider or the zipper chain. In some embodiments, the jaws may not apply a direct compressional force when engaged, but instead may engage teeth engagement features with the zipper teeth elements.

In some embodiments, both jaws are movable jaws, meaning that both jaws move with respect to the greater structure, or frame, of the zipper stopper. In some embodiments, one of the jaws is movable and the remaining jaw or jaws are fixed with respect to the greater structure, or frame, of the zipper stopper. When the term “jaw” is invoked in this application without describing the jaw as movable or fixed, then “jaw” refers to either a movable jaw or fixed jaw. When the term “jaws” is invoked in this application without describing the jaws as movable of fixed, then “jaws” refers to at least one movable jaw and at least one other movable or fixed opposing Jaw.

Each jaw may have a jaw proximal end, a jaw distal end, a jaw distal end interior side, and an intermediate jaw face. The jaw proximal end is defined as the part of a jaw which is coupled to the actuatable structure. The jaw proximal underside is defined as the underside surface or surfaces of the jaw, jaw frame, or simply “frame.” The jaw distal end is defined as the part of the jaw which is further away from the actuatable structure which is applied and engaged to the zipper or zipper components. The jaw distal end interior side generally refers to the innermost surface, face, or section of the jaw distal end or jaw tread.

In some embodiments, both jaws may be part of a single zipper stopper body or structure. This is to say that the jaws and the actuatable structure, which enables the jaws to be engaged and disengaged, may be formed from one continuous body or monolithic structure. For example and without limitation, a zipper stopper may be constructed using a mono-cast injection molding technique. In another example, the zipper stopper may be made from an elastomeric material, a thermoplastic material, a food-safe rubber material such as ethylene propylene diene monomer (EPDM), metals, or other material with elastic deformation properties. In some embodiments, the actuatable structure may be a living hinge, also referred to as an integral hinge. A living hinge may be a flexible structure which enables the jaws to be engaged and disengaged.

In some embodiments, the material flexibility and/or the geometry of the actuatable structure may allow the user to pull the jaws apart, elastically deforming the actuating structure into a disengaged position, before applying the zipper stopper. When applying the zipper stopper the user may release the jaws, allowing the actuating structure to return towards its at-rest configuration. Entering the at-rest position may bring the jaws into an engaged position. In some embodiments, the user may not need to pull the jaws apart directly. In some embodiments, there may be a jaw separating feature which, when actuated, separates or disengages the jaws by elastically deforming the actuatable structure.

In some embodiments, one or more of the jaws may be configured with a jaw pad. In some embodiments, the jaw pad may be the surface through which a compressive force of the jaws may be transmitted. Zipper stopper jaw pads may not be present in all embodiments of the zipper stopper.

In some embodiments, the jaw pad or pads may be capable of independently sliding, rotating, pivoting, or otherwise articulating with respect to the jaw(s). In some embodiments, the jaw pad may be fixed to the jaw. In still other embodiments the jaw pad may be integrated with the jaw itself, forming a continuous body. In some embodiments, the jaw pad may be smooth, textured, or otherwise specifically shaped to provide improved engagement performance or to interact with the teeth elements.

In some embodiments, the zipper stopper may be configured with a chain engagement feature. The chain engagement feature may be a protrusion or indentation disposed on the jaw proximal end inner side, jaw proximal end underside, the jaw distal end inner side, or the intermediate jaw face which spans between the distal end and the proximal end. In some embodiments, the chain engagement feature may be a pin which is inserted into one or more gaps between the teeth elements of the zipper. In some embodiments, the chain engagement feature may be a series of serrations, a ridge, a fin, a shaped void space, or shape which serves as a means to engage a zipper chain.

In some embodiments, the zipper stopper may be configured with a slider engagement feature. The slider engagement feature may be a pin which is inserted through an aperture disposed on the zipper slider, pull tab, or any portion of the zipper slider assembly. The slider engagement feature may be any other means by which some portion of the zipper slider assembly is connected to the zipper stopper.

In some embodiments, the zipper stopper may be configured with a keeper attachment feature, or simply “keeper”. The keeper attachment feature may be flexibly connected to the zipper stopper by a tether or the keeper may be fixed to the zipper stopper. The purpose of the keeper attachment feature is to be able to connect the zipper stopper to the garment, or other convenient location. The keeper attachment feature will keep the zipper stopper handy and help prevent misplacing the zipper stopper when the zipper stopper is not engaged around the zipper slider or zipper chain.

In some embodiments, the zipper stopper jaws are engaged, disengaged, or locked in place by spinning a spinning feature. In some embodiments, said spinning feature may be attached to a threaded shaft, screw, spring, spool, gear, axle, pawl arm, or other actuatable component. In some embodiments, the spinning feature may be a handle which the user may grip. In some embodiments, the spinning feature is a specially shaped feature which may be spun with a separate tool. The purpose of using a tool may be to prevent undesired spinning of the spinning feature. In some embodiments, the spinning feature may be restrained in a recess or cavity. For example and without limitation, the spinning feature may be a handle, wheel, a dial, a crank, a serrated pin.

There are a wide variety of actuatable structures which may accomplish the goal of bringing the jaws of the zipper stopper into or out of compression. Some possible actuatable structures are described below. This list of actuatable structures is not exhaustive and does not include all possible actuatable structure embodiments.

In some embodiments, the actuatable structure resembles a C-Clamp design. The C-Clamp design may have a threaded shaft which is threaded through the zipper stopper frame, also referred to as the “frame”. In some embodiment, the fixed jaw is immovably connected to the zipper stopper frame or integrated with the zipper stopper frame. The threaded shaft has two ends. In some embodiments, the interior end of the threaded shaft, which is the end nearest to the fixed jaw, may be considered the movable jaw. The movable jaw may be configured with a jaw pad which is free to slide, rotate, pivot, or otherwise articulate independently from the movable jaw.

In some embodiments, attached to the distal end of the movable jaw is a spinning feature. The spinning feature may be a T-handle. The handle may be fixed to the movable jaw such that rotating the handle in one direction rotates the threaded shaft within the zipper stopper frame and moves the movable jaw towards the fixed jaw, engaging the jaws. Rotating the handle in the opposite direction moves the movable jaw away from the fixed jaw, disengaging the jaws. In some embodiments, the spinning feature may have a specially shaped recess which may be spun with a removable handle. The purpose of using a removable handle is to prevent spinning of the threaded shaft when the handle is removed.

In some embodiments, the actuatable structure of the zipper stopper resembles a bar clamp design. The zipper stopper may have a plurality of laterally oriented slide bars. At one end of the slide bar or bars a jaw may be attached. An opposing jaw or jaw frame may have a slide bar guide into which the slide bar may be inserted. The slide bar may translate longitudinally within the slide bar guide.

The zipper stopper may incorporate a stopper lock feature. In some embodiments, the stopper lock feature may be engaged to prevent the jaws from moving with respect to each other. In some embodiments, the stopper lock feature may be engaged to prevent the jaws from moving away from each other. In some embodiments, the zipper stopper may incorporate a lock release feature which disengages the zipper lock feature. The stopper lock feature may take many different forms depending on the embodiment. In some embodiments, the zipper stopper may incorporate a plurality of stopper lock features. In some embodiments, when engaging the zipper stopper, a jaw may be slid towards the opposing jaw and then held in place by the stopper lock feature.

The stopper lock feature may incorporate a spring or spring system. In some embodiments, a stopper lock feature with a spring or spring system may be spring loaded to enter into the locked state. In some embodiments, a stopper lock feature with a spring or spring system may be spring loaded to enter the unlocked state.

In some embodiments, the stopper lock feature may be a threaded article of male hardware, a threaded shaft, which may be inserted into a threaded hole disposed within a jaw or jaw frame. This hole may be referred to as a frame hole. After the jaws are engaged the user may spin the threaded shaft of the lock feature until the distal end of the threaded shaft contacts and presses against the slide bar, thereby holding the jaws in place.

In some embodiments, the slide bar may have a slide bar hole. In some embodiments, the stopper lock feature may be screwed down through the slide bar hole, thereby placing the zipper stopper in a locked position.

In some embodiments, the actuatable structure of the zipper stopper resembles a latch clamp design. In some embodiments, one or more of the jaws have latch inserts which may be inserted into a corresponding latch receiver attached to or disposed within the opposing jaw. In some embodiments, these latch inserts may be flexible such that as the jaws are brought into compression, the latch is bent, placing the latch and/or zipper chain into stress. In some embodiments, the latch insert may have a hooking feature, and the latch receiver may have one or more corresponding receiver ledges onto which the hooking feature may gain purchase. As the jaws are brought closer together, the latch insert or inserts reach a sufficient depth within the latch receiver such that the hooking feature is sprung around a receiver ledge. The contact the hooking feature makes with the receiver ledge prevents the jaws from being pulled apart.

After the latch or latches have been engaged with the receiver ledge, the user may need to disengage the hooking feature from the receiver ledge before the jaws may be released. In some embodiments, a latch handle is coupled or attached to the latch insert such that the user may disengage the latch insert from the receiver ledge by pushing, pulling, or otherwise manipulating the latch handle.

In some embodiments, the actuatable structure zipper stopper resembles a rack clamp design. The zipper stopper may have a plurality of laterally oriented rack bars. The rack bars are serrated sections of an overall housing structure to which the jaws are attached. The rack bar or bars are attached to the housing such that the jaws may move longitudinally along the length of the rack bar. A gear may be attached or coupled to a concentric shaft. The teeth of said gear may be engaged such that they mesh with the serrations of the rack bar or bars. The shaft may also be configured with a spinning feature such that spinning the spinning feature spins the shaft, which spins the gear attached to the shaft, which engages with the bar serrations, and produces linear motion of the movable jaw along the rack bar or bars.

The zipper stopper may utilize a pawl arm as a type of stopper lock feature. The gear may have a second set of serrations, or pawl serrations, which engage with the pawl arm. The pawl arm may have a pawl tab which is configured to mesh with the pawl serrations such that the pawl prevents the jaws from disengaging. The pawl arm may be coupled or attached to a handle such that the user may disengage the pawl arm from the pawl serrations by pushing, pulling, or otherwise manipulating the handle.

In some embodiments, the actuatable structure of the zipper stopper resembles a twist clamp design. The zipper stopper may have a threaded rod, or power screw, which is coupled at one end block. The power screw may be inserted through a hole in the block and a jaw may be attached to the block. The other end of the power screw may be threaded through a threaded block, the threaded block being pivotally connected to the opposing jaw or to an arm of the opposing jaw. Said power screw may be configured with a spinning feature, or screw handle, such that spinning the screw handle spins the power screw, which translates the threaded nut along the power screw. The translation of the threaded block, which is attached to the opposing jaw or opposing jaw lever arm, engages the jaws towards each other. In some embodiments, the jaw arms are connected together by pivot point. In some embodiments the jaw arms form an actuatable structure involving a plurality of pivot points. The arms may be pivotally coupled together by screws, pins, or similar at the pivot points.

In some embodiments, the actuatable structure of the zipper stopper resembles a pincer clamp design. The jaw arms may be pivotally connected at their crossing or intersection by a pin or axle. In some embodiments, a spring is configured to hold the clamp closed such that the user must apply force to the jaw arms to open the jaws. The user may engage the jaws by applying a force to the jaws or to the jaw arms such that the jaws pivot about their connection point bringing the jaws towards each other.

In some embodiments, the actuatable structure resembles a pull-gear design. One or more of the jaws, or jaw frames, may have serrations. These serrations may interlock with a gear which is oriented perpendicular to the serrated jaw arm or jaw arms. The gear may have a spinning feature such that the user may spin the gear. As the user spins the gear it causes the serrated arms to travel laterally. If the user rotates the spinning feature in one direction one or more jaw arms are brought towards each other into compression. If the user rotates the spinning feature in the opposite direction one or more jaw arms are pushed away from each other, loosening the clamp.

In some embodiments, the actuatable structure involves a spring, or spring system. The actuatable structure which connects the jaws may be in-part in or whole a spring. The spring may be variety of spring types including, but not limited to, a chained spring, a compression spring, a torsion spring or a living hinge spring. In some embodiments, the spring system is loaded such that when the zipper stopper is at rest the jaws are engaged towards each other. The user may apply a force to the jaws, or to the jaw arms coupled to the jaws, to separate the jaws. As the user releases the jaw separating force the jaws will return towards each other due to the spring force. In some embodiments, the jaw, the spring, and the opposing jaw may form a single continuous body.

In some embodiments, the jaws or jaw frames are coupled together by a cable or wire. The cable may be placed in tension by a spring system such that the spring system pulls the jaws together.

In some embodiments, the actuatable structure of the zipper stopper is made from an elastic material. The actuatable structure which connects the two jaws may be in-part or in whole made from an elastic material. In some embodiments, the elastic material may be elastically stretched such that when the stretching force is removed the elastic material generally returns to its pre-stretched length. In some embodiments, the elastic material connects the jaws or the jaw arms. The user may engage the jaws by moving the jaws away from each other, placing the jaws around the zipper slider or zipper chain, and releasing the jaws, allowing the elastic material to return the jaws towards each other, thereby engaging the jaws.

In some embodiments, a jaw handle may be coupled or attached to one or more jaws. The jaw handle may provide the user with a feature to grip in order to engage, disengage, lock, or unlock the zipper stopper.

In some embodiments, the zipper stopper is has two or more attachment features which are connected to each other. At least one attachment feature may be configured to attach the zipper stopper to the zipper teeth elements, left zipper tape, right zipper tape, or to the fabric to which either zipper tape is connected. This attachment feature is referred to as the mounting element. The mounting element may be a clamp, clip, pin, or other suitable attachment device. At least one other attachment feature may be configured to attach the zipper stopper to the zipper slider or zipper pull tab. This attachment feature is referred to as the retaining element. The retaining element may be a clamp, clip, pin, hook, shackle, carabiner, loop, magnet, or other suitable attachment device. The mounting element and the retaining element are directly or indirectly connected to each other. In some embodiments, the mounting feature is attached on the side of the zipper slider which is opposite to the zipper chain. In some embodiments, the zipper stopper retains the zipper slider by holding the mounting element and the retaining element together. If the user, or other motive force, attempts to slide the zipper slider towards the zipper chain the retaining element of the zipper stopper will apply an opposing force to the zipper slider.

In some embodiments, the zipper stopper may have an optional keeper element installed or integrated to the zipper stopper. The keeper element is meant to keep the zipper stopper readily available to the user. The user may attach the keeper element to the zippered garment such that when the zipper stopper is disengaged the zipper stopper is not lost or misplaced. The user may follow the keeper element from its attachment point to the garment to its connection to the zipper stoper. The keeper feature may be a clamp, clip, pin, shackle, carabiner, or other suitable attachment mechanism. The keeper element may be flexibly or inflexibly attached to the zipper stopper.

Also disclosed is a method of using the zipper stopper. In the preferred method of using the zipper stopper the zipper stopper is applied to the zipper to prevent or hinder the zipper slider from sliding along the zipper chain, thereby separating the zipper tapes. In different embodiments of the method the zipper stopper may be applied to components or areas of the zipper.

In some embodiments, the zipper stopper may be applied to the zipper slider. The first step of this method is to position the zipper stopper around or over the zipper slider in such a way that it couples the zipper slider to the zipper tape, one or more zipper chains, or the fabric to which the zipper tape is coupled, thereby preventing the separation of the zipper tapes. In some embodiments, one or more jaws may be positioned to the left side of the zipper slider, and one or more jaws may be positioned to the right side of the zipper slider. In some embodiments, one or more jaws may be positioned behind the zipper slider, and one or more jaws may be positioned in front of the zipper slider. The user may then engage the zipper stopper such that the jaws are brought towards each other around the zipper slider. It is not necessary that all zipper stopper jaws make direct contact with the zipper slider or zipper chain. In some embodiments, the jaw contact pads may in part or in whole apply a compressive force to the adjacent zipper tape, zipper chain, or adjacent fabric to the zipper slider. The compressive force may be translated through the adjacent materials to the zipper slider. In some embodiments, the frictional force between the adjacent materials and the zipper slider is intended to resist movement of the zipper slider with respect to the adjacent materials, holding the zipper slider in place along the zipper tapes. In some embodiments, the zipper stopper may prevent the zipper slider from separating the zipper chain by binding, constraining, or non-destructively deforming the zipper chain, zipper tape, adjacent fabric, or some combination thereof such that the zipper slider is prevented from sliding towards the zipper chain. In some embodiments, an aperture may exist in the zipper stoper through which the zipper slider is placed and a portion of the zipper stoper is connected to a component of the zipper or fabric to which the zipper tape is attached, thereby preventing the zipper slider from substantially moving along the zipper tapes.

In some embodiments, the zipper stopper may be applied to the zipper chain. The first step of this method is to position the jaws of the zipper stopper around the zipper chain. In some embodiments, one or more jaws may be positioned to the left side of the zipper chain, and one or more jaws may be positioned to the right side of the zipper chain. In some embodiments, one or more jaws may be positioned behind the zipper chain, and one or more jaws may be positioned in front of the zipper chain. The user may then engage the zipper stopper such that the jaws are brought towards each other around the zipper chain. It is not necessary that all zipper stopper jaws make direct contact with the zipper chain. In some embodiments, the jaw contact pads may in part or in whole apply a compressive force to the adjacent zipper tape, zipper chain, adjacent fabric, or some combination thereof. The compressive force may be translated through the adjacent materials to the zipper chain. In some embodiments, the zipper stopper may prevent the zipper slider from separating the zipper chain by compressing the two zipper tapes of the zipper chain together. In some embodiments, the zipper stopper may prevent the zipper slider from separating the zipper chain by physically contacting the zipper slider, preventing the zipper slider from sliding towards the zipper chain. In some embodiments, the zipper stopper may prevent the zipper slider from separating the zipper chain by binding, constraining, or non-destructively deforming the zipper chain, zipper tape, adjacent fabric, or some combination thereof, such that the zipper slider is prevented from sliding towards the zipper chain. [locking mechanism]

In some embodiments, the zipper stopper may apply a force to the fabric or zipper tape material behind the zipper slider or behind the zipper chain. The first step of this method is to position the jaws of the zipper stopper around the zipper slider or zipper chain such that the jaw contact pads are around the zipper slider or zipper chain. In some embodiments, one or more jaws may be positioned behind the left side of the zipper chain, and one or more jaws may be positioned behind the right side of the zipper slider or zipper chain. The user may then engage the zipper stopper such that the jaws are brought towards each other, pinching the fabric or zipper tape behind the zipper stopper or zipper chain. It is not necessary that all zipper stopper jaws completely avoid contact with the zipper slider or zipper chain. The compressive force may be applied in part or in whole to the fabric or zipper tape, or some combination thereof. This compressive force generates a frictional force between the zipper stopper and the fabric or zipper tape which resists movement of the zipper stopper with respect to the fabric or zipper tape. In some embodiments, the zipper stopper may prevent the zipper slider from separating the zipper chain by physically contacting the zipper slider, preventing the zipper slider from sliding towards the zipper chain. In some embodiments, the zipper stopper may prevent the zipper slider from separating the zipper chain by binding, constraining, or non-destructively deforming the zipper chain, zipper tape, adjacent fabric, or some combination thereof such that the zipper slider is prevented from sliding towards the zipper chain.

In some embodiments, the zipper stopper may be removably attached to the zipper or garment and removably attached to the zipper slider or zipper pull tab. In some embodiments, the first step of this method of using the zipper stopper may be to attach the mounting element of the zipper stopper to the zipper or garment. The second step of this embodiment may be to attach retaining element of the zipper stopper, to the zipper slider, or zipper pull tab. In some embodiments, the user may first attach the zipper stopper to the zipper or garment by engaging a clamp, clip, pin or other mounting element around or through the zipper teeth elements, left zipper tape, right zipper tape, or to the fabric to which either zipper tape is connected. In some embodiments, the mounting element may be fixed to the frame of the zipper stopper. In some embodiments, the mounting element may be connected to the zipper stopper by a flexible tether. In some embodiments, the order of the steps may be reversed. In such an embodiment, the first step of the method may be to attach the retaining element of the zipper stopper to the zipper slider or zipper pull tab. The second step of this embodiment may be to attach the mounting element of the zipper tape, or elsewhere on the zippered garment. The zipper stopper of this embodiment may be held in tension between the mounting element and the zipper slider, preventing the zipper slider from sliding away from the location of the mounting element.

In the embodiments described herein, it should be appreciated that each of the components of the zipper stopper and related system described herein may be manufactured and/or assembled in accordance with the conventional knowledge and level of a person having skill in the art.

While various details, features, combinations are described in the illustrated embodiments, one having skill in the art will appreciate a myriad of possible alternative combinations and arrangements of the features disclosed herein. As such, the descriptions are intended to be enabling only, and non-limiting.

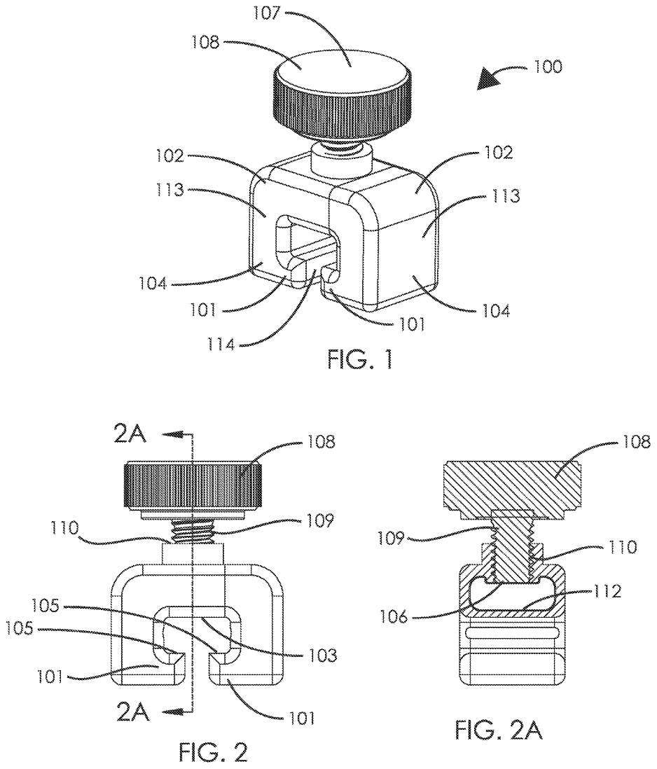

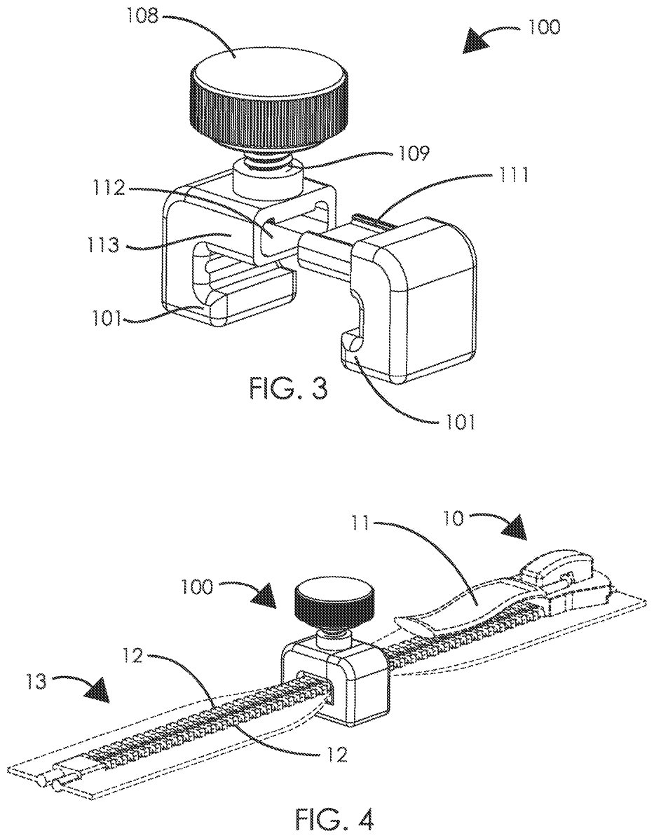

Referring now to the drawings, the first illustrated embodiment is shown in FIG. 1-FIG. 4. The zipper stopper embodiment 1 (100) has opposing jaws (101), each jaw having a jaw proximal end (102) and a jaw distal end (104). The general location of the jaw proximal underside (103) and the jaw distal end interior side (105) are shown in FIG. 2. This embodiment has a stopper lock feature (106) which forms a threaded shaft (109) which passes through a threaded hole (110) in a jaw frame (113). There is a spinning feature (107) disposed on the threaded shaft, which in this embodiment is a handle (108). When engaged the threaded shaft presses against the slide bar (111), the friction between the threaded shaft and the slide bar help to hold the two jaws in place. The slide bar is inserted into the slide bar guide (112). The jaw pad (114) may generally refer to the interior side of a jaw, and in some embodiments it refers to the surface area of a jaw on a jaw's distal end which is substantially in closest proximity to an opposing jaw.

In FIG. 4 the zipper stopper embodiment 1 (10) is applied to the zipper chain (13). The zipper slider (10), zipper pull tab (11), and two zipper tapes are also shown in FIG. 4.

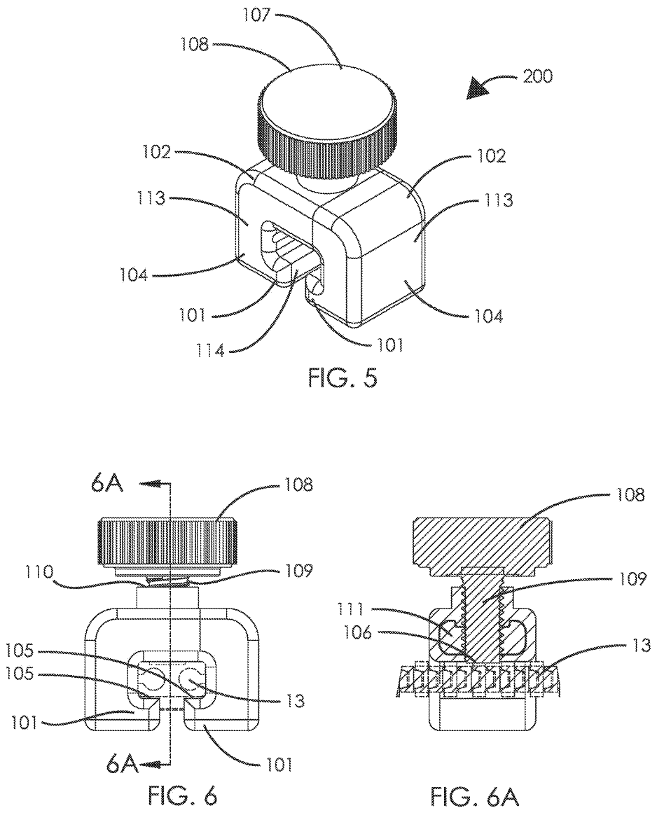

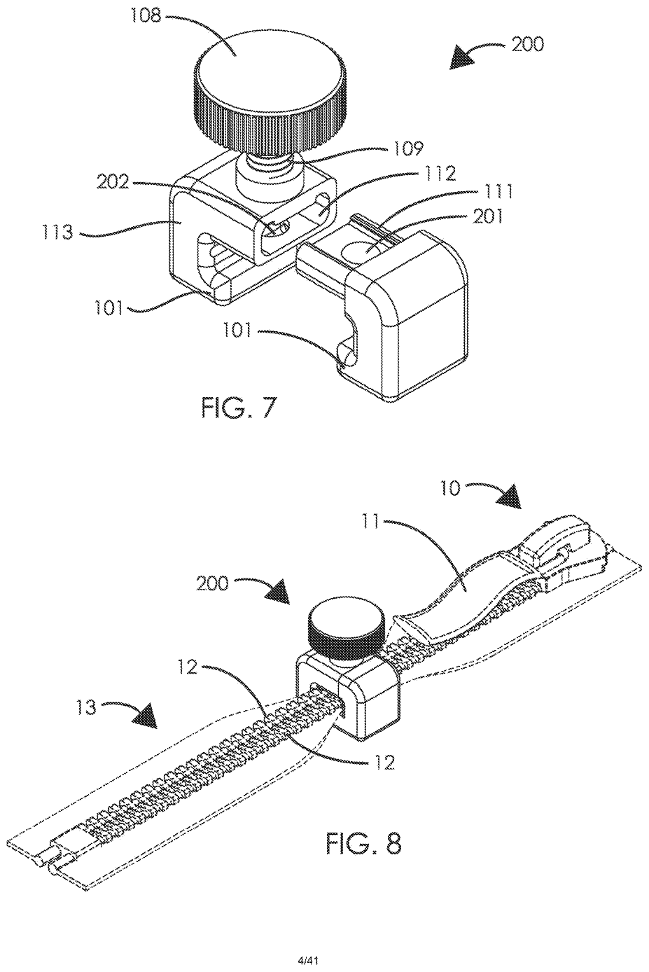

The second illustrated embodiment is shown in FIG. 5-FIG. 8. The zipper stopper embodiment 2 (200) has a similar general structure to the zipper stopper embodiment 1 (100). However, the zipper stopper embodiment 2 has a slide bar hole (201) through which the stopper lock feature (106) may pass. In addition, the frame (113) has a frame hole (202) through which the stopper lock feature may pass. When the stopper is applied to the zipper and the stopper lock feature is engaged, the stopper lock feature may press against the zipper, helping to hold the zipper stopper and zipper in place. The stopper lock feature may be coupled to one or more elements not shown in the drawing which may make direct contact with the zipper chain.

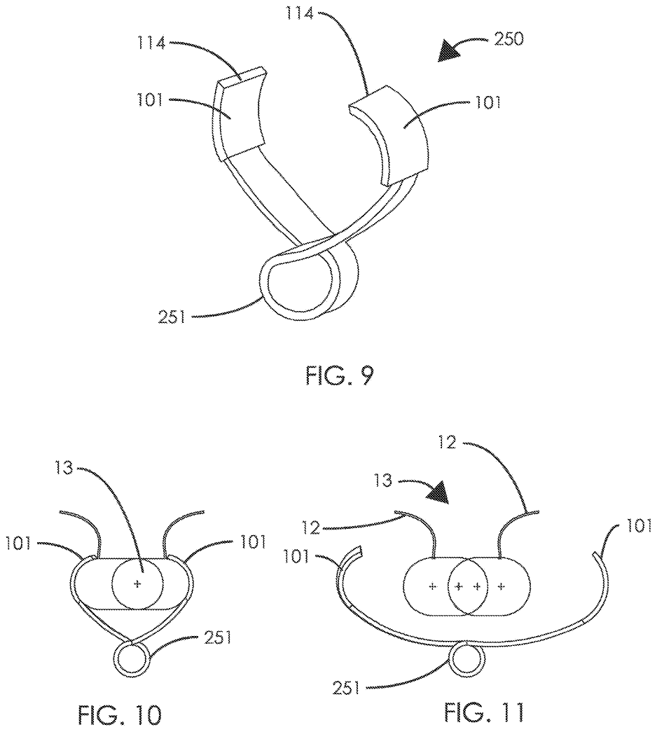

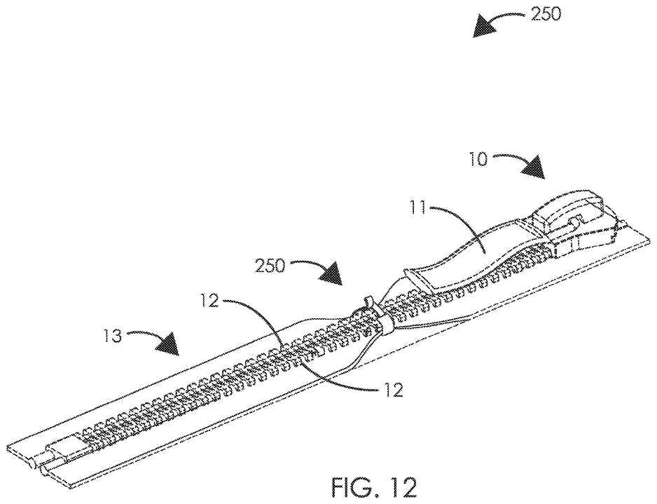

The third illustrated embodiment is shown in FIG. 9-FIG. 12. The zipper stopper embodiment 3 (250) has opposing jaws (101). The jaws are attached to each other through an actuatable structure. The actuatable structure is a spring system (251). The spring system is made of a partially elastic material such that the user may separate the jaws, place the jaws around the zipper, release the jaws, and the jaws will move towards their at-rest position, engaging the zipper stopper around the zipper.

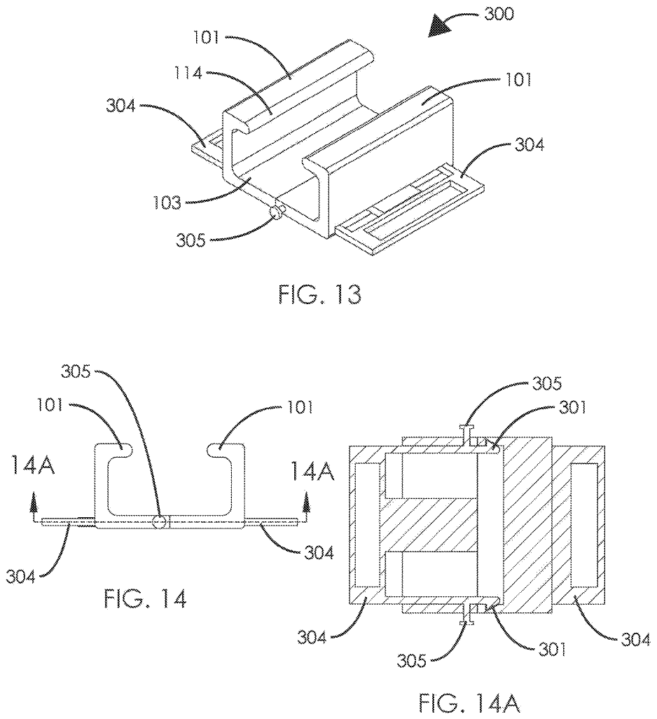

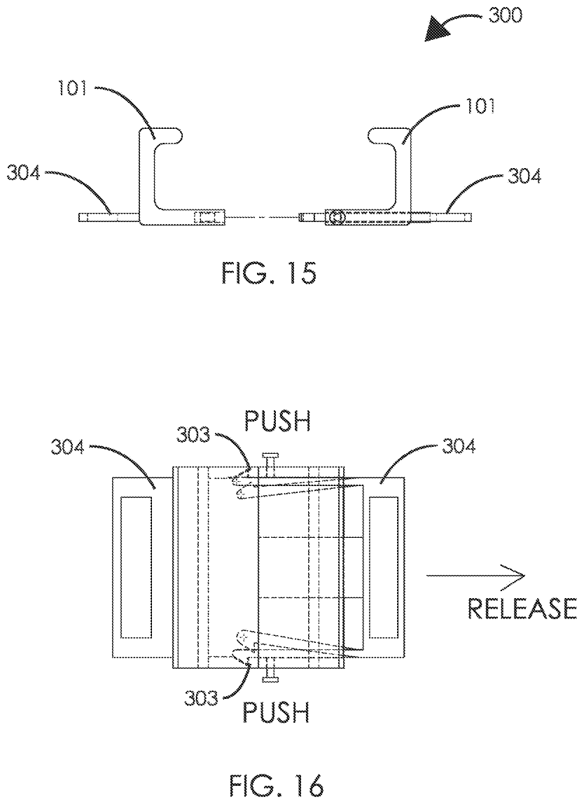

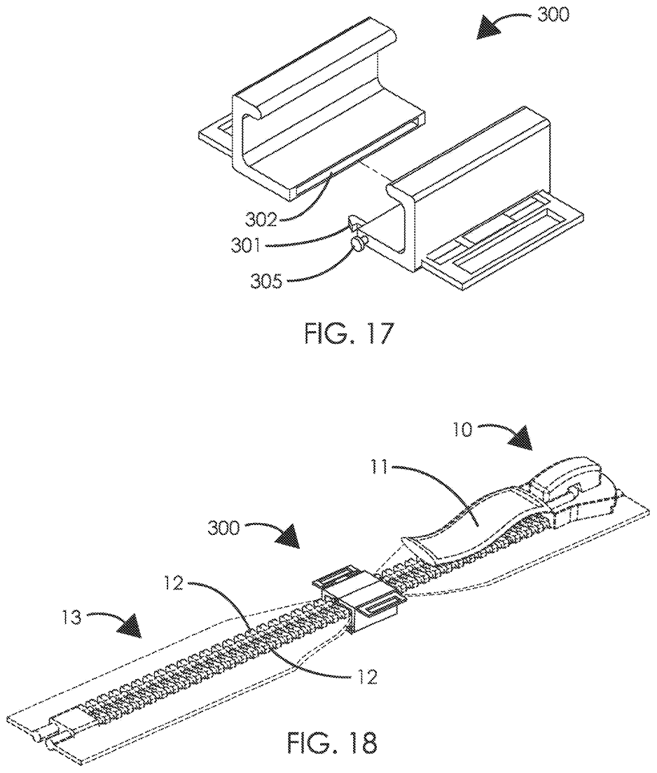

The fourth illustrated embodiment is shown in FIG. 13-FIG. 18. The zipper stopper embodiment 4 (300) has opposing jaws (101). One of the jaws is attached to a set of latch inserts (301). The other jaw is attached to a latch receiver (302). The latch receiver has two receiver ledges

(303) to engage the two latch inserts. The latch inserts and receiver ledge form the stopper lock feature for this embodiment (106). The user may grip the latch handles (304) of the jaws and press the jaws together until the latch engages the receiver ledge, thereby holding the jaws towards each other around the zipper. This embodiment includes a lock release feature (305) which, when actuated, can release the latch inserts from the receiver ledges.

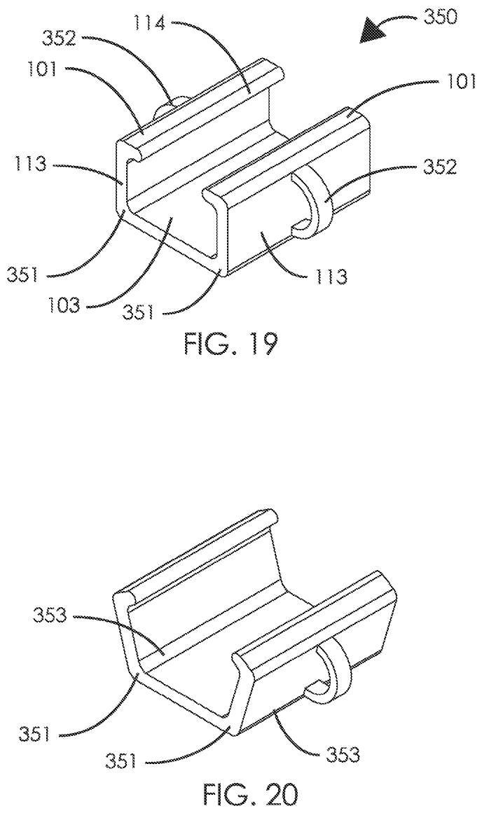

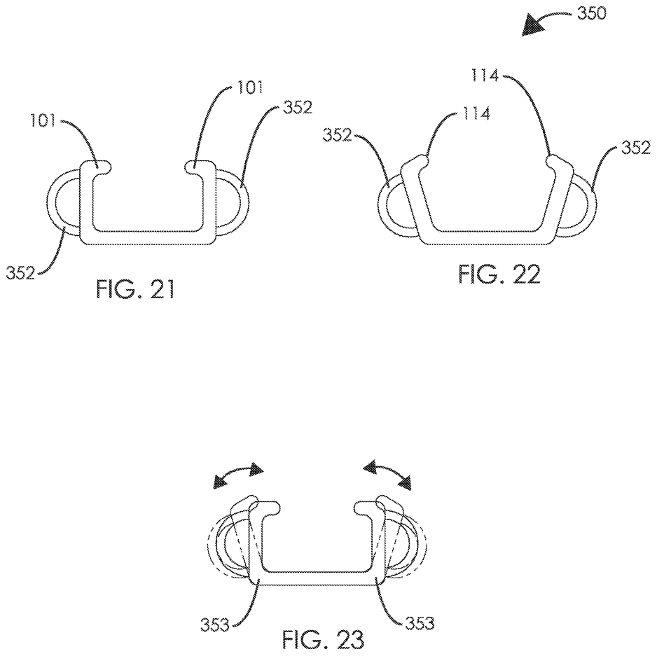

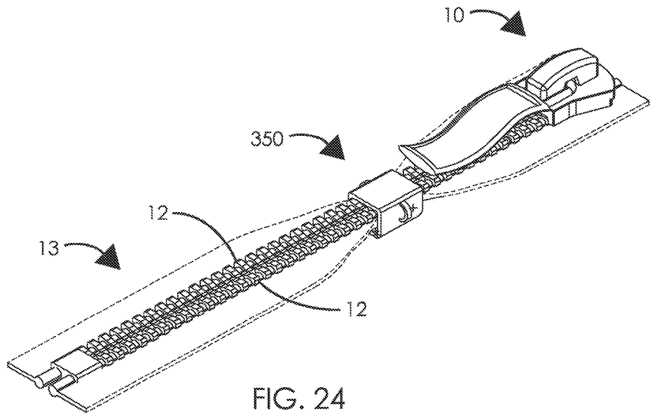

The fifth illustrated embodiment is shown in FIG. 19-FIG. 24. The zipper stopper embodiment 5 (350) has opposing jaws (101). Each of the jaws are attached to a living hinge (353) such that when the user pulls the jaws apart the elastic material (351) of the living hinge deforms. When the user releases the jaws the elastic material will return towards its at rest position, engaging the jaws of the stopper. The jaws are attached to the frames (113) which have jaw handles (352) to help the user actuate the jaws.

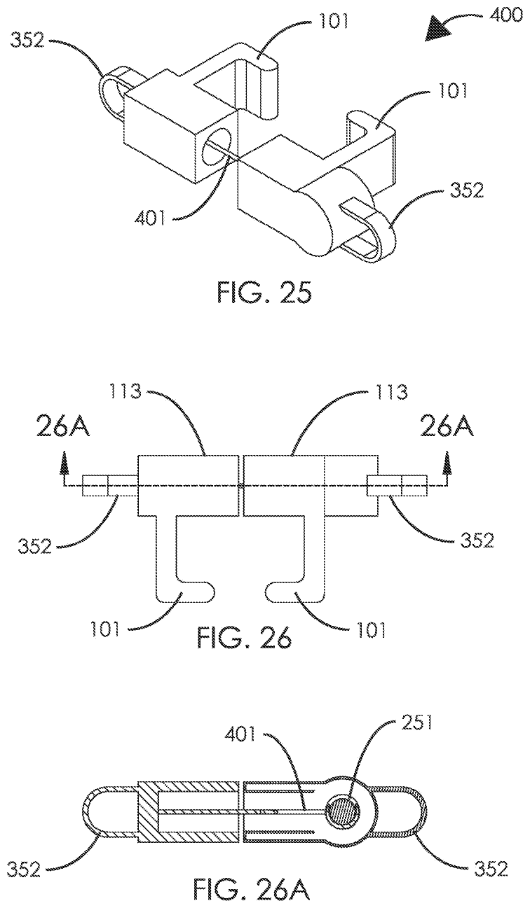

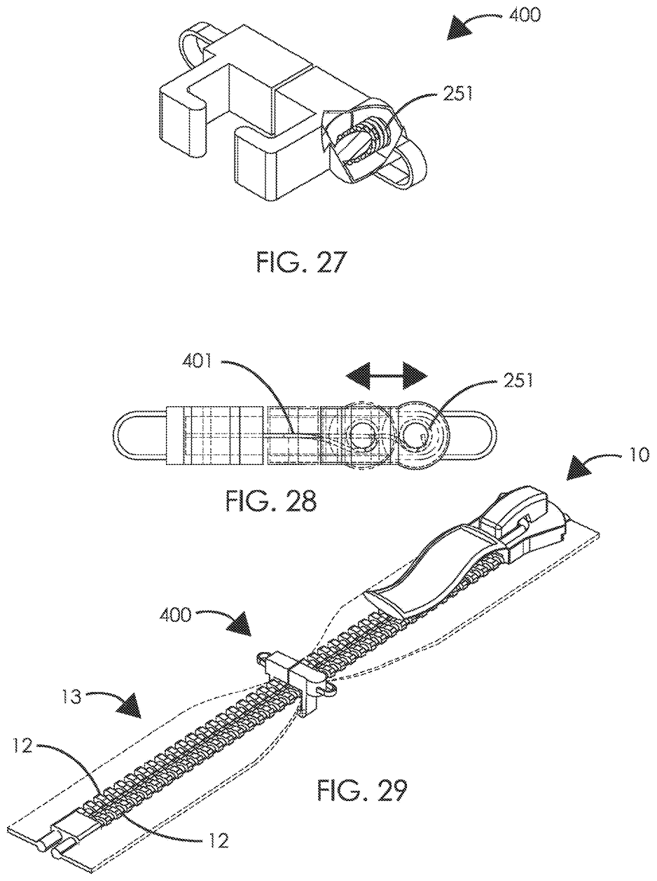

The sixth illustrated embodiment is shown in FIG. 25-FIG. 29. The zipper stopper embodiment 6 (400) has opposing jaws (101). The opposing jaws are pulled together by a cable (401). The cable is attached to a spring system such that when the user separates the jaw handles (352) the spring is deformed. The spring system applies tension to the wire pulling the jaws together when the user releases the jaws.

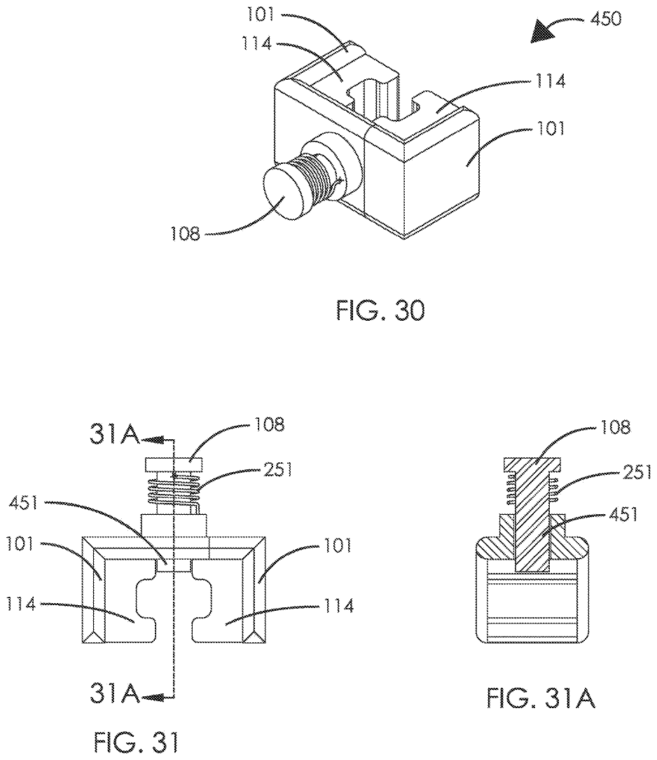

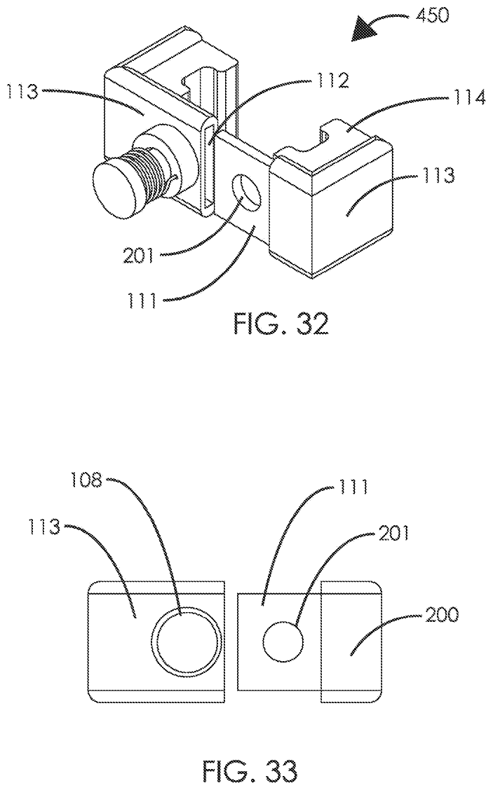

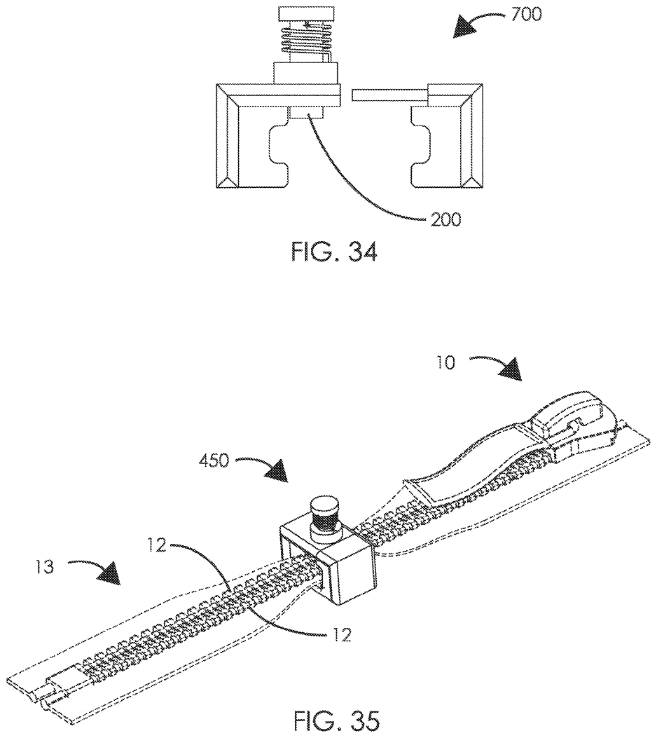

The seventh illustrated embodiment is shown in FIG. 30-FIG. 35. The zipper stopper embodiment 7 (450) has opposing jaws (101). This embodiment has a similar general structure to the zipper stopper embodiment 2 (200). However, the stopper lock feature (107) is a mechanism involving a stopper pin (451) and spring system (251). When the zipper stopper is applied to the zipper, the user may engage the stopper pin against the zipper, thereby holding the zipper stopper in place around the zipper. This embodiment shows compressible jaw pads (114) made of an elastic material which allow the user to squeeze the jaws closed until the pin engages. The jaw pads continue to exert a compressive force after the pin is engaged.

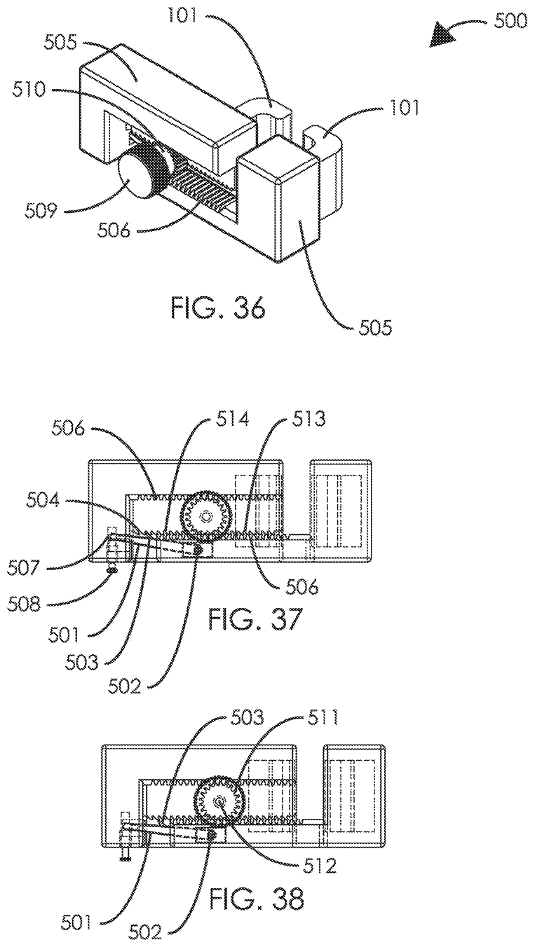

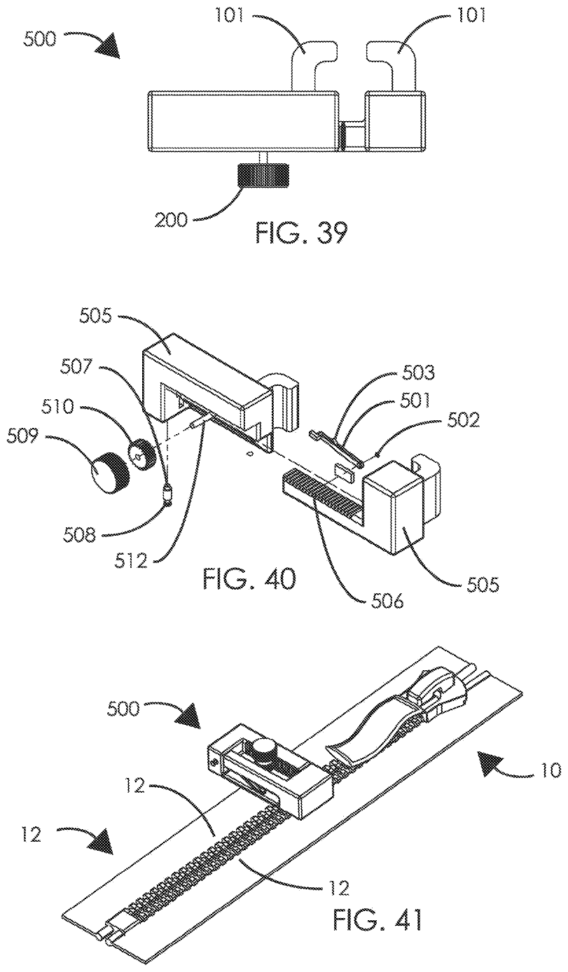

The eighth illustrated embodiment is shown in FIG. 36-FIG. 41. The zipper stopper embodiment 8 (500) has opposing jaws (101). One jaw is attached to a housing (505). The other jaw is attached to another housing (505). The housings has housing teeth (506) along which the gear teeth (511) of the gear (510) mesh and travel. The gear has a gear handle (509) attached allowing the user to spin the gear by spinning the gear handle. The gear and the gear handle are concentric about the gear axle (512). There is also a rack (513) or rack bar disposed on one of the housings which has a set of rack teeth (514) serrations (504). There is a pawl arm (501) attached to one housing which pivots or bends around a pawl pivot (502) point. The pawl arm may be actuated by a push/pull actuator (507) which is attached to a push/pull button (508) which the user may engage into the push or pull positions. When the push/pull actuator is moved by the user, it moves the pawl tab (503) into or out of engagement with the rack teeth of the rack. The pawl tab, when engaged with the rack, prevents the jaws from separating and serves as the stopper lock feature (106).

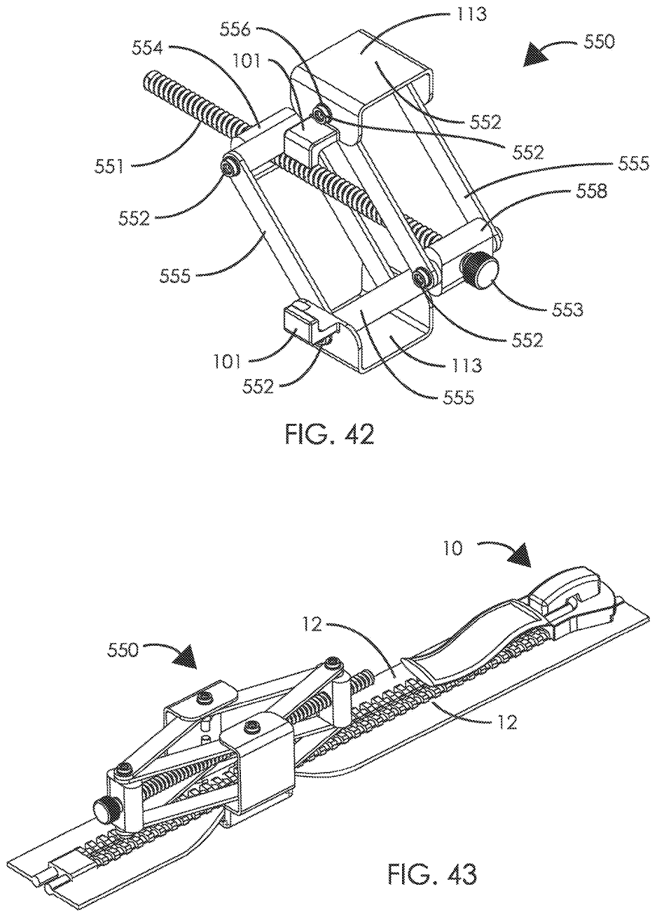

The ninth illustrated embodiment is shown in FIG. 42-FIG. 43. The zipper stopper embodiment 9 (550) has opposing jaws (101). The actuatable structure of this embodiment is a system of arms (555) which are held together by screws (552) and washers (556). In other embodiments, the screws could be replaced with any component which enables rotational motion, such as pins. There is a threaded block (554) attached to one end of the arm system and regular block (558) attached to the other end of the arm system. A power screw (551) which passes through the block is threaded into the threaded block. When the user spins the handle attached to the power screw, the threaded block travels along the power screw, and the jaws are engaged towards or away from each other.

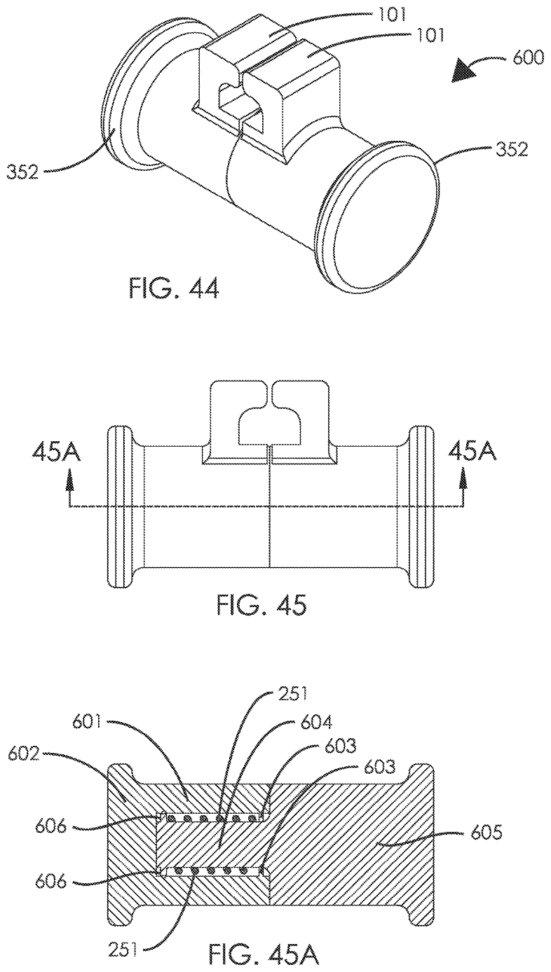

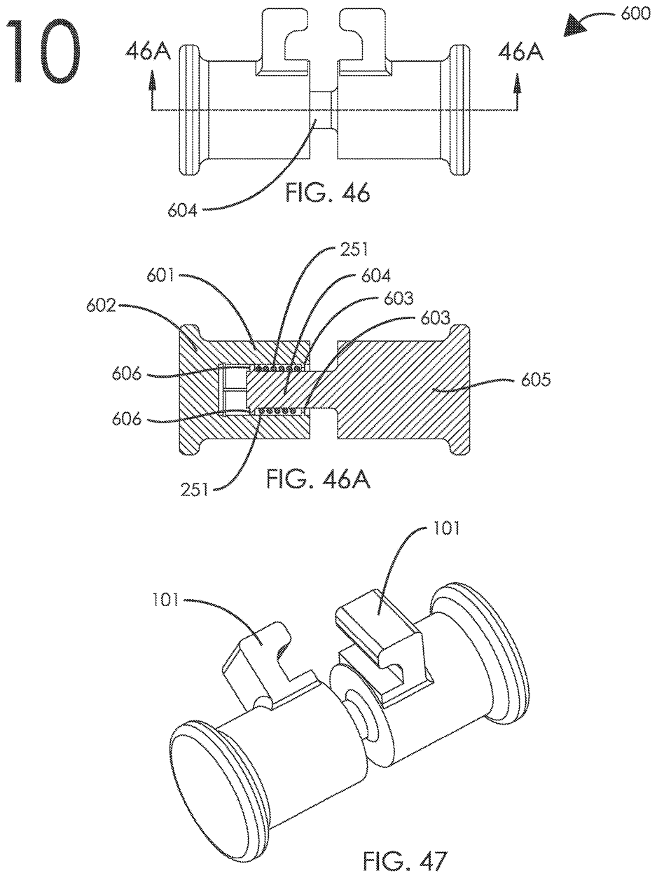

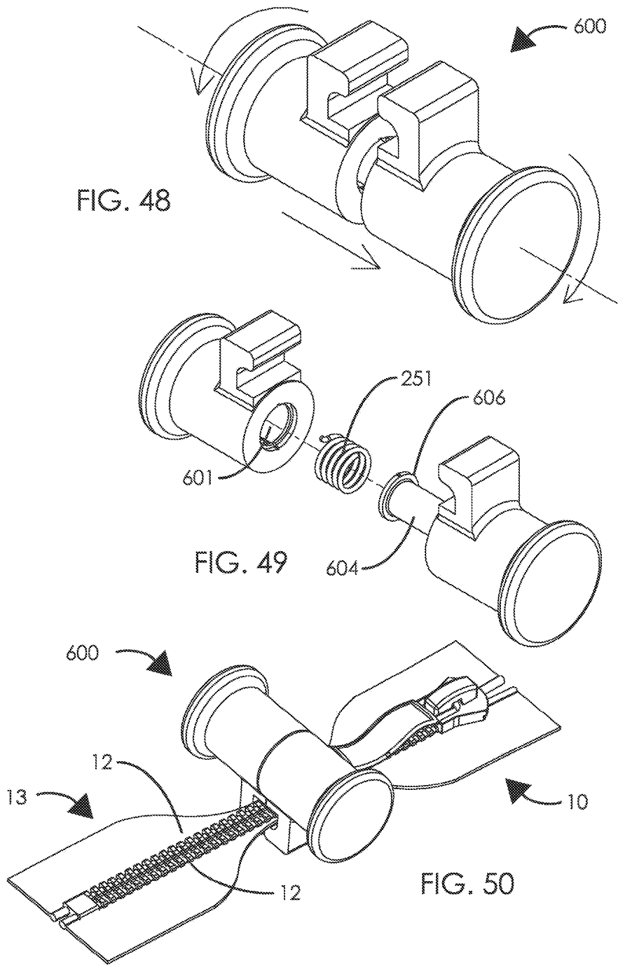

The tenth illustrated embodiment is shown in FIG. 44-FIG. 50. The zipper stopper embodiment 10 (600) has opposing jaws (101). One jaw is attached to the push pull casing (601). The push pull casing is attached to the greater push pull casing frame (602). The other jaw is attached to the push pull tube (604). The push pull tube is attached to the greater push pull tube frame (605). The push pull tube is inserted into the push pull casing. A spring system is captured between the push pull tube and the push pull casing by the casing spring retainer (603) and the tube spring retainer (606). In this embodiment, the jaws can be rotated for a greater ease of attachment and removal, as seen in FIG. 47 and FIG. 48.

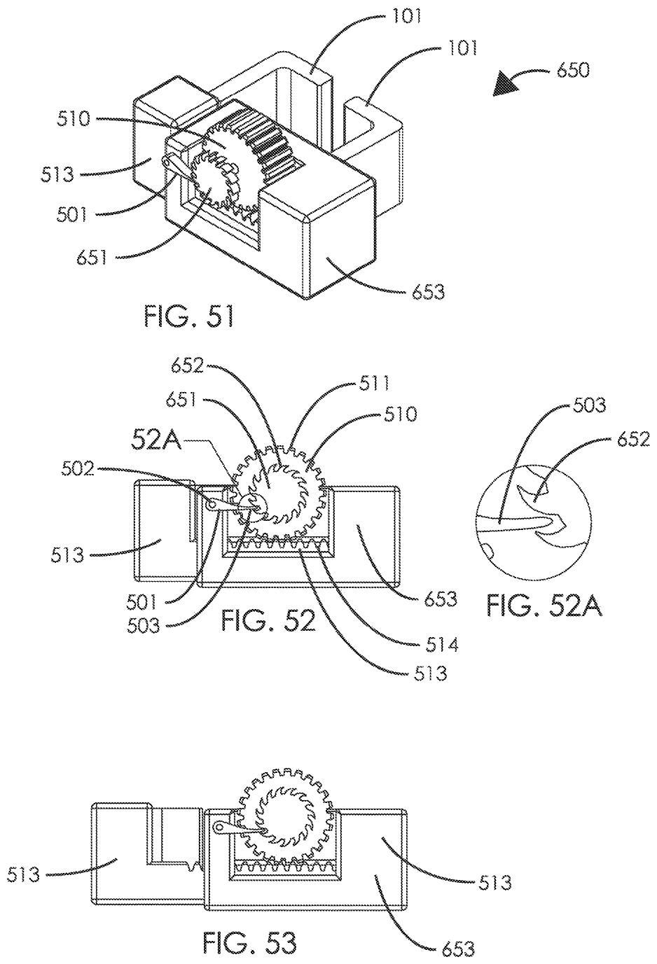

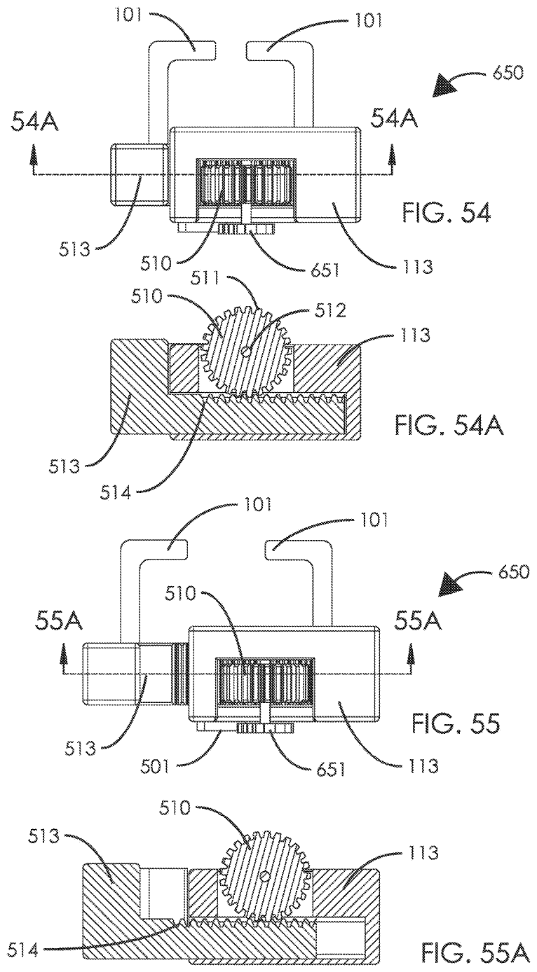

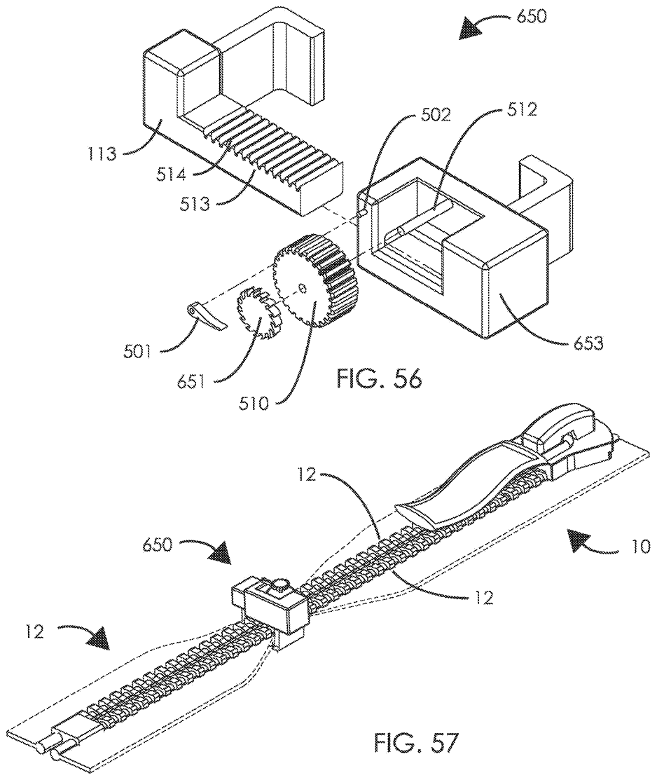

The eleventh illustrated embodiment is shown in FIG. 51-FIG. 57. The zipper stopper embodiment 11 (650) has opposing jaws (101). This embodiment has a concentrically aligned gear (510) and ratchet (651). One jaw is attached to the rack housing (653), and the other jaw is attached to the rack (513). The rack teeth (514) are meshed with the gear such that when the gear is spun the rack translates. A pawl arm (501) is attached to the rack housing and it engages with the ratchet teeth (652) of the ratchet. The pawl engagement with the ratchet prevents the jaws from opening and therefore serves as the stopper lock feature (106).

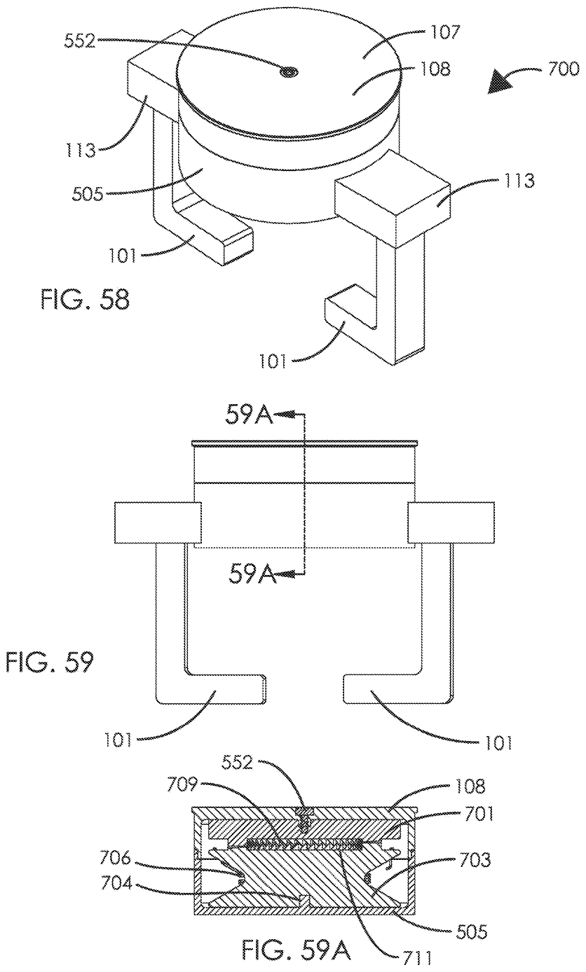

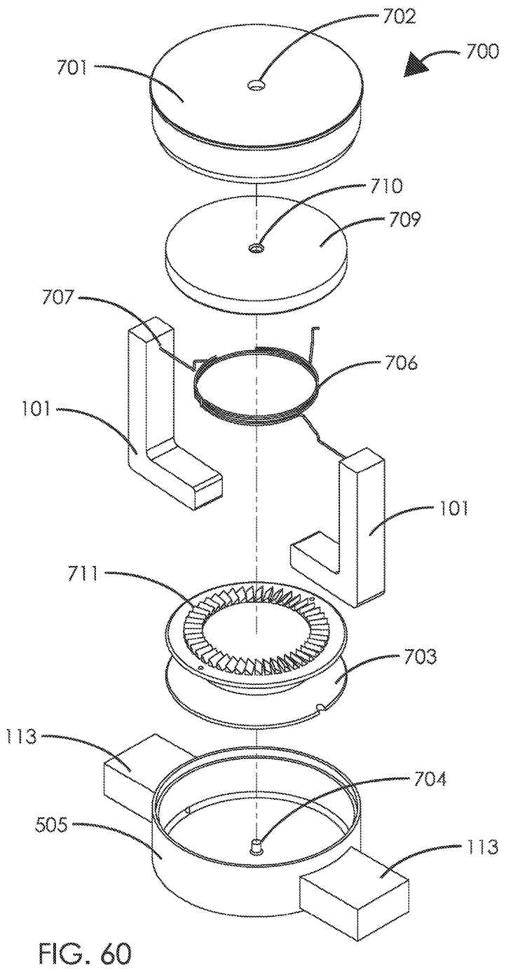

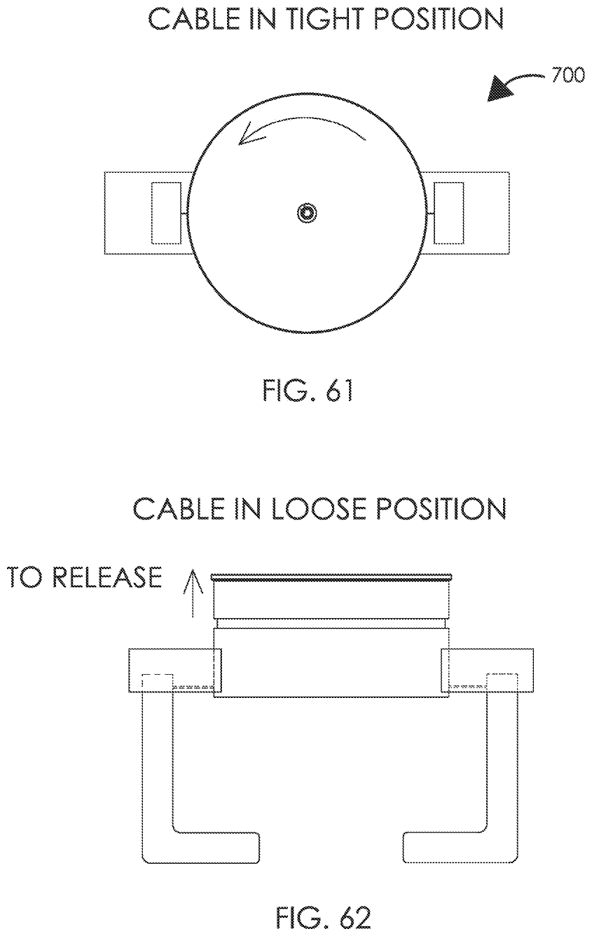

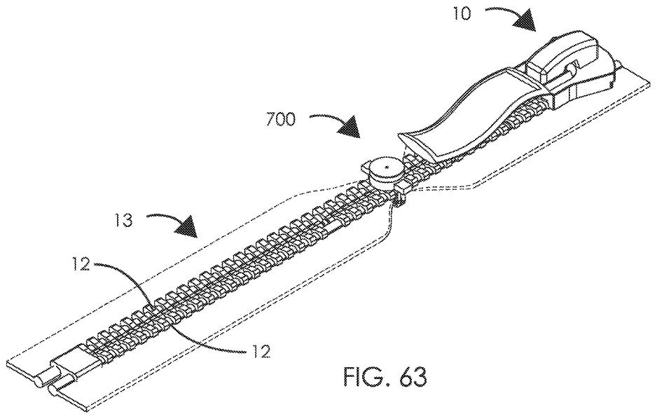

The twelfth illustrated embodiment is shown in FIG. 58-FIG. 63. The zipper stopper embodiment 12 (700) has opposing jaws (101). The jaws may be engaged together by a user squeezing the jaws towards each other. There is an internal spinning gear system which prevents the jaws from opening back up, thereby serving as the stopper lock feature (106). This system has a spinner (701) centered on a spinner hole (702). Below the spinner is a top gear (709) centered on a top gear threaded hole (710). Below the top gear is a spool (703) centered on a spool axle (704) and surrounded by a spool housing (705). Disposed on top of the spool is a bottom gear (701). The bottom gear meshes with the top gear. Between the two gears is a spool cable (706) which is inserted into a plurality of spool cable insert holes (707). The user may release the stopper lock mechanism by lifting up on the spinner.

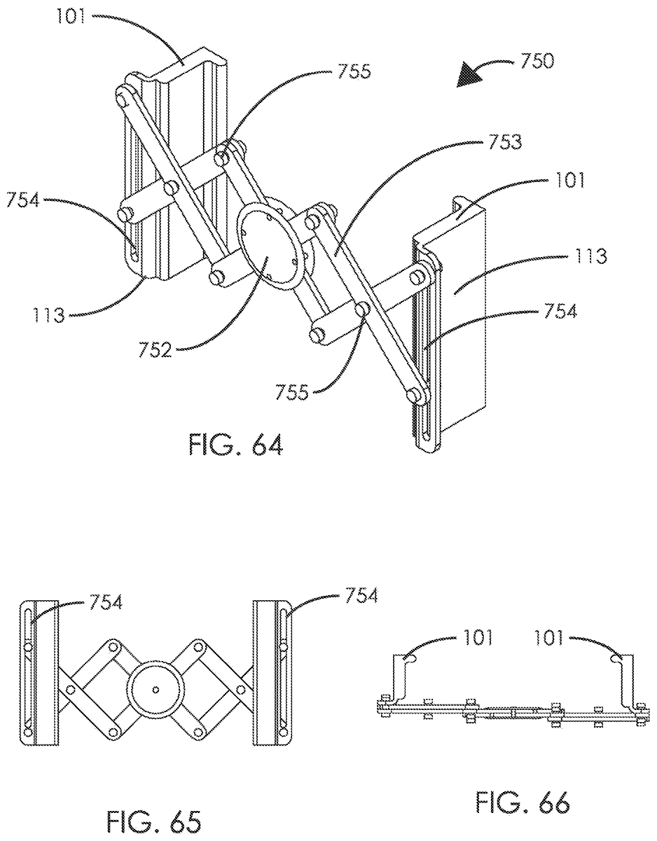

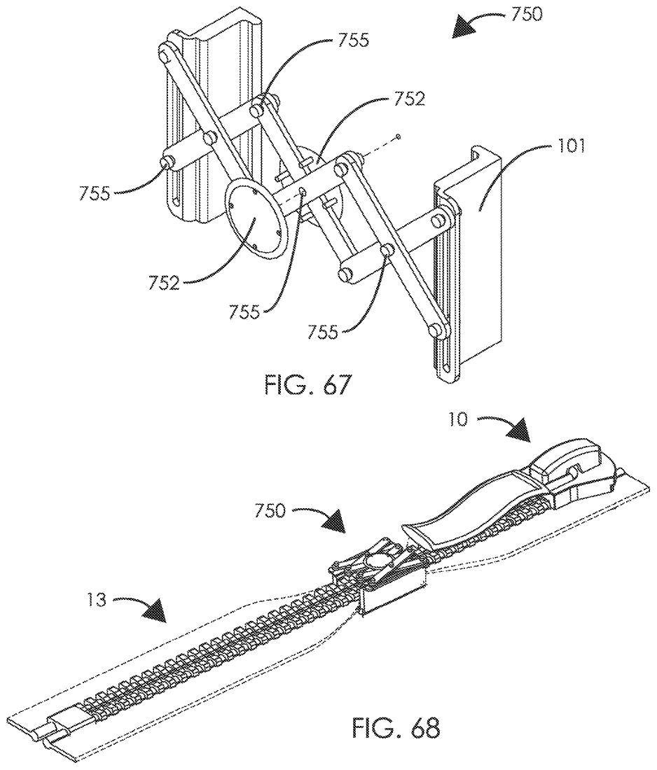

The thirteenth illustrated embodiment is shown in FIG. 64-FIG. 68. The zipper stopper embodiment 13 (750) has opposing jaws (101). The actuatable structure of this embodiment is a system of scissor arms (753) which are held together by scissor pivots (755). One jaw is attached to one side of the scissor arm structure, and the other jaw is attached to the other side of the scissor arm structure. The jaw frames (113) have scissor arm slides (754) which allow one of the two arms attached to the frame to translate within the scissor arm slide. At the center of the scissor arm structure is a lock plate (752) which may be actuated after the jaws are engaged towards each other such that the jaws are held in the engaged position. The lock plate serves as a stopper lock feature (106) for this embodiment.

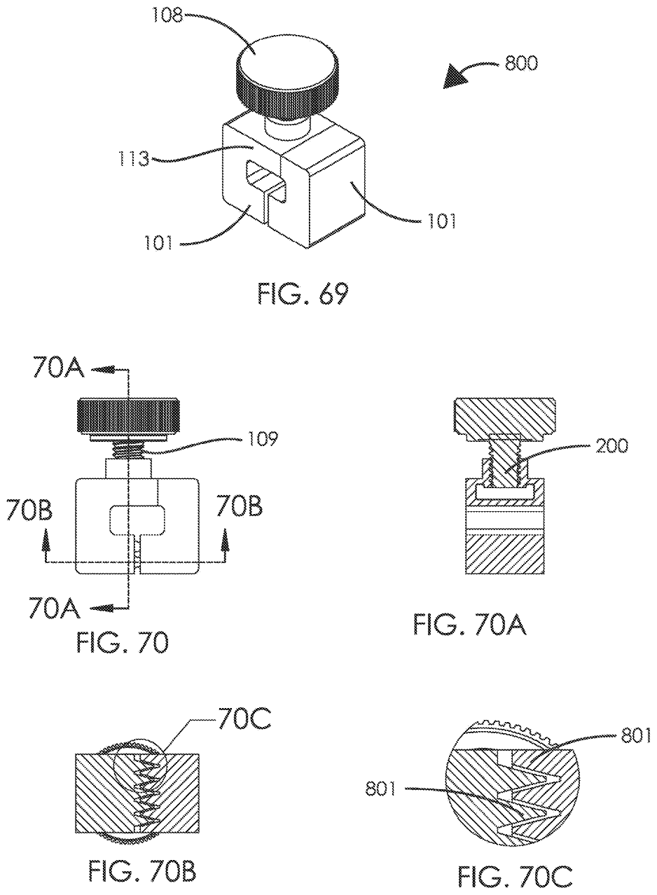

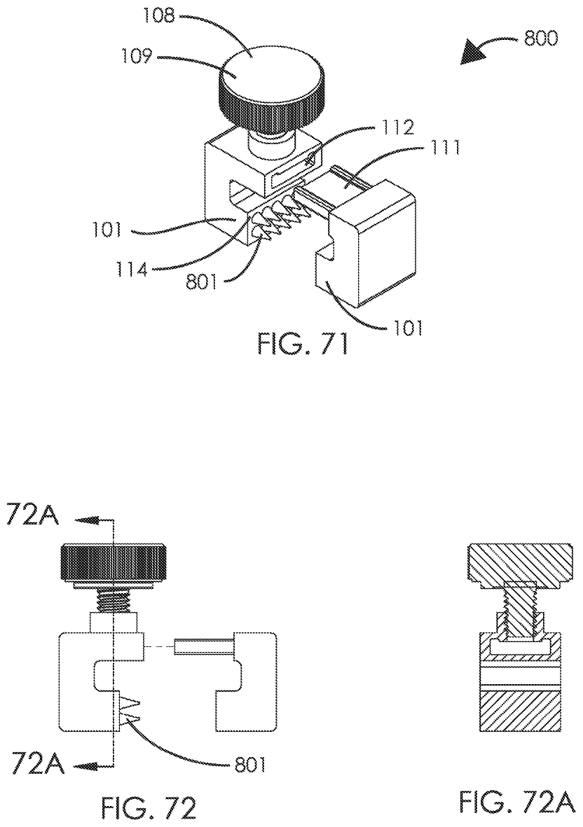

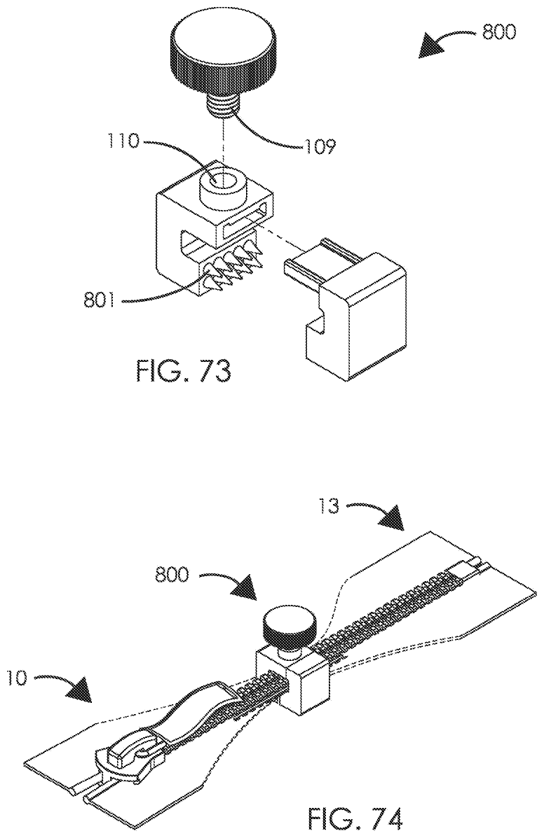

The fourteenth illustrated embodiment is shown in FIG. 69-FIG. 74. The zipper stopper embodiment 14 (800) has opposing jaws (101) and a similar general structure to the zipper stopper embodiment 1 (100). However, this embodiment has jaw tread (801) in the jaw pad (114) area. Jaw tread may be used on a variety of different embodiments to improve the gripping ability of the zipper stopper.

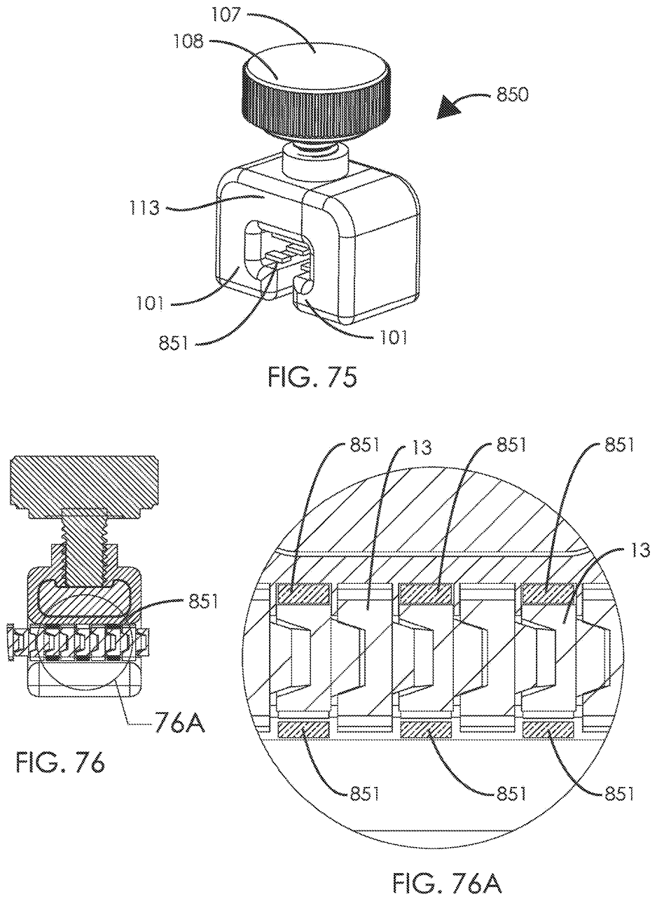

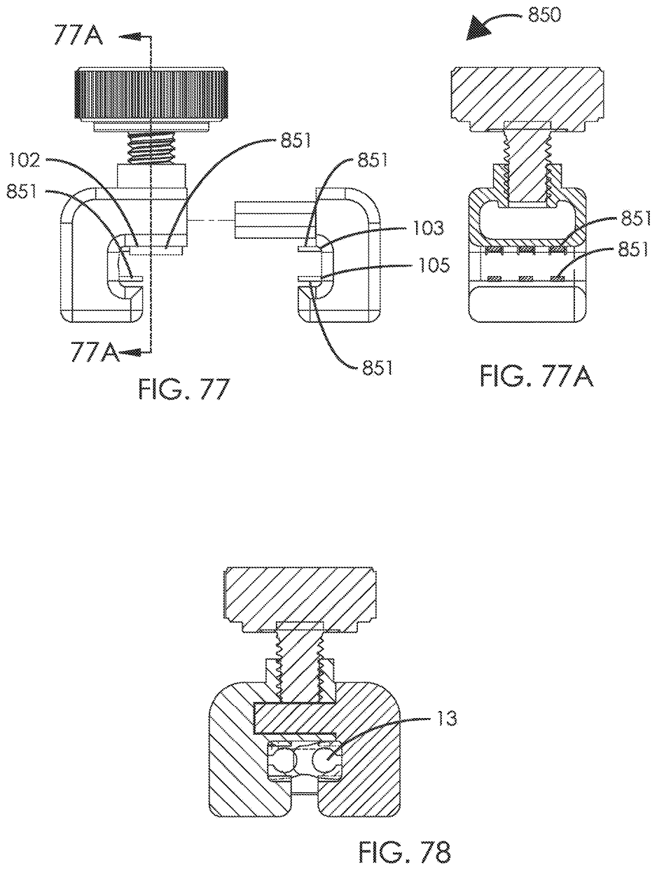

The fifteenth illustrated embodiment is shown in FIG. 75-FIG. 78. The zipper stopper embodiment 15 (850) has opposing jaws (101). This zipper stopper has chain engagement features (851) which can engage with the zipper chain. The chain engagement features are disposed on the jaw proximal underside (103) and the jaw distal end interior side (105). These features experience a shear force when the user tries to move the zipper stop along the zipper chain rather than a friction force as seen in many other embodiments.

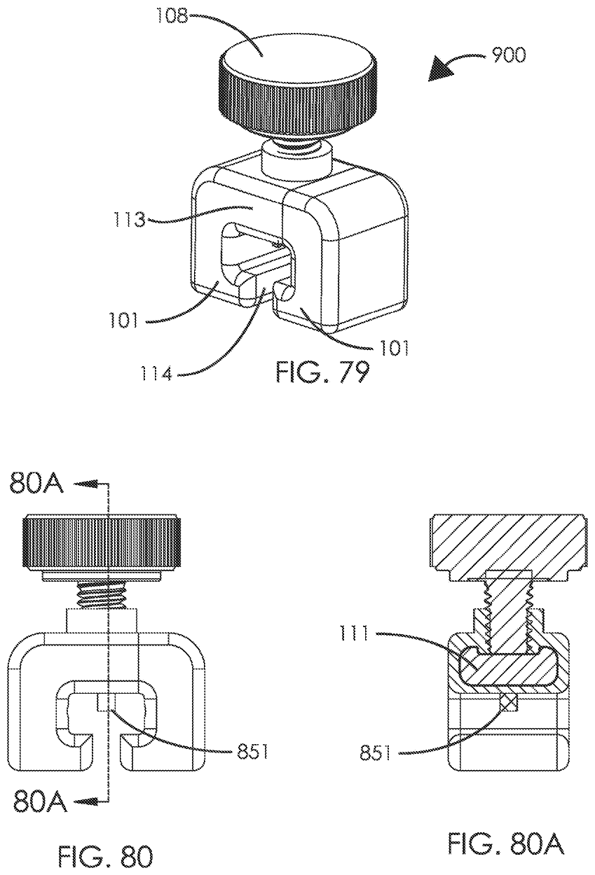

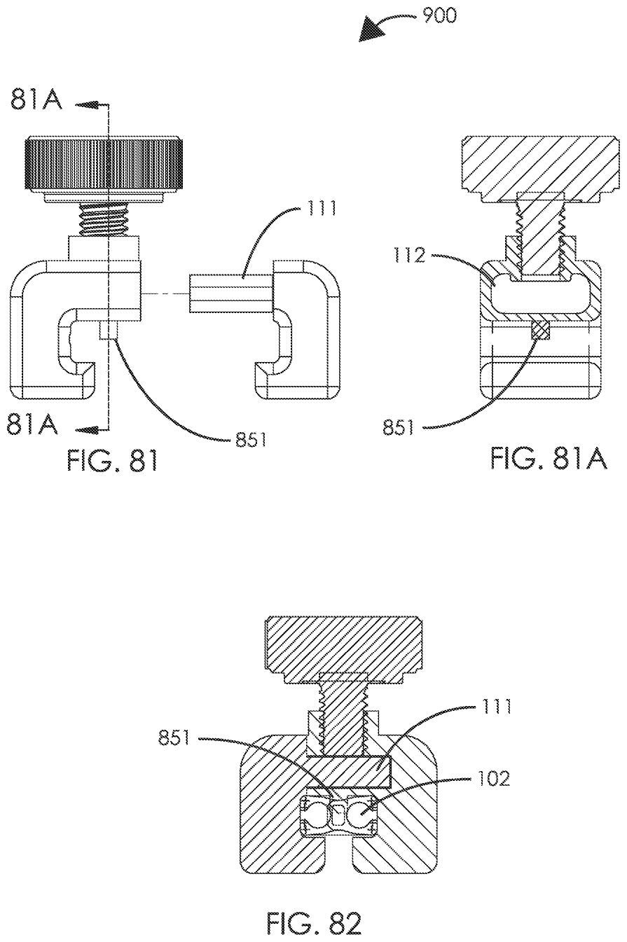

The sixteenth illustrated embodiment is shown in FIG. 79-FIG. 82. The zipper stopper embodiment 16 (900) has opposing jaws (101). Similar to the fifteenth illustrated embodiment this zipper stopper has a chain engagement features (851) which can engage with the zipper chain. The chain engagement feature is disposed on the jaw proximal underside (103). This engagement feature may be comparable in shape or size to any of the pins currently used in many locking zipper sliders.

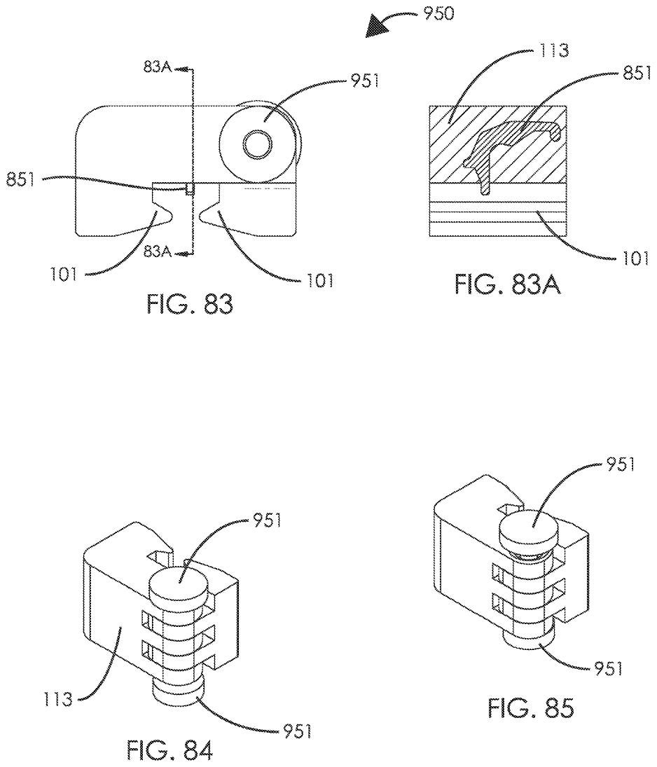

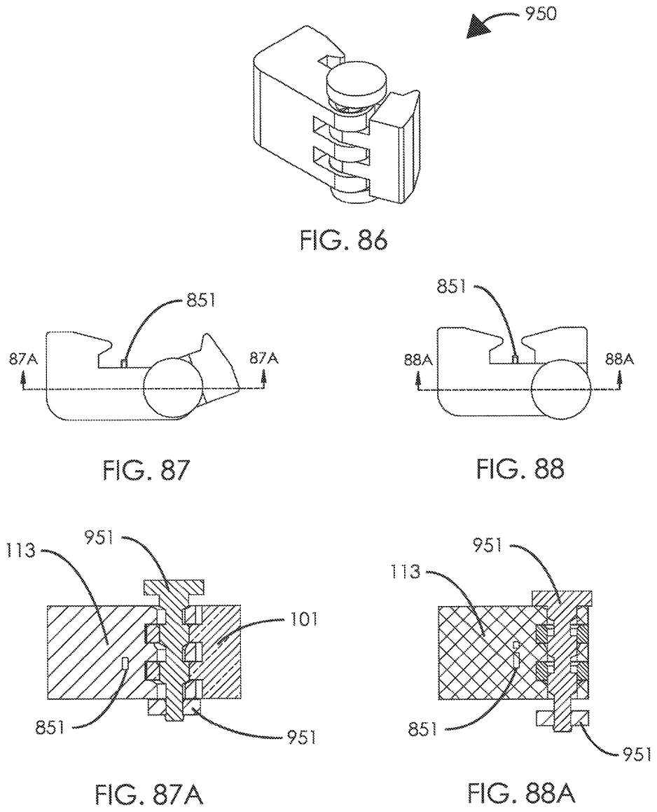

The seventeenth illustrated embodiment is shown in FIG. 83-FIG. 88A. The zipper stopper embodiment 17 (950) has opposing jaws (101). The actuatable structure in this embodiment is a hinge. The hinge may be moved along its rotating axis to hold the jaws in their engaged position. The movement of the hinge is the stopper lock feature in this embodiment. This embodiment also has a chain engagement feature which may make contact with the chain when the stopper is engaged around the chain.

### FEATURE LIST

Zipper Slider (10)
Zipper Pull Tab (11)
Zipper Tape (12)
Zipper Chain (13)
Zipper Stopper Embodiment 1 (100)
Jaw (101)
Jaw Proximal End (102)
Jaw Proximal Underside (103)
Jaw Distal End (104)
Jaw Distal End Interior Side (105)
Stopper Lock Feature (106)
Spinning Feature (107)
Handle (108)
Threaded Shaft (109)
Threaded Hole (110)
Slide Bar (111)
Slide Bar Guide (112)
Frame (113)
Jaw Pad (114)
Zipper Stopper Embodiment 2 (200)
Slide Bar Hole (201)
Frame Hole (202)
Zipper Stopper Embodiment 3 (250)
Spring System (251)
Zipper Stopper Embodiment 4 (300)
Latch Insert (301)
Latch Receiver (302)
Receiver Ledge (303)
Latch Handle (304)
Lock Release Feature (305)
Zipper Stopper Embodiment 5 (350)
Elastic Material (351)
Jaw Handle (352)
Living Hinge (353)
Zipper Stopper Embodiment 6 (400)
Cable (401)
Zipper Stopper Embodiment 7 (450)
Stopper Pin (451)
Zipper Stopper Embodiment 8 (500)
Pawl Arm (501)
Pawl Pivot (502)
Pawl Tab (503)
Serrations (504)
Housing (505)
Housing Teeth (506)
Push/Pull Actuator (507)
Push/Pull Button (508)
Gear Handle (509)
Gear (510)
Gear Teeth (511)
Gear Axle (512)
Rack (513)
Rack Teeth (514)
Zipper Stopper Embodiment 9 (550)
Power Screw (551)
Screw (552)
Screw Handle (553)
Threaded Block (554)
Arm (555)
Washer (556)
Pin (557)
Block (558)
Zipper Stopper Embodiment 10 (600)
Push Pull Casing (601)
Push Pull Casing Frame (602)
Casing Spring Retainer (603)
Push Pull Tube (604)
Push Pull Tube Frame (605)
Tube Spring Retainer (606)
Zipper Stopper Embodiment 11 (650)
Ratchet (651)
Ratchet teeth (652)
Rack Housing (653)
Zipper Stopper Embodiment 12 (700)
Spinner (701)
Spinner Hole (702)
Spool (703)
Spool Axle (704)
Spool Housing (705)
Spool Cable (706)
Spool Cable Insert Hole (707)
Top Gear (709)
Top Gear Threaded Hole (710)
Bottom Gear (711)
Zipper Stopper Embodiment 13 (750)
Lock Plate (752)
Scissor Arm (753)
Scissor Arm Slide (754)
Scissor Pivot (755)
Zipper Stopper Embodiment 14 (800)
Jaw Tread (801)
Zipper Stopper Embodiment 15 (850)
Chain Engagement Feature (851)
Zipper Stopper Embodiment 16 (900)
Zipper Stopper Embodiment 17 (950)
Hinge (951)

The embodiments disclosed herein may be further described with reference to the following aspects:

Aspect 1: A zipper stopper comprising: a pair of opposing jaws including at least a first jaw and a second jaw opposing the first jaw, the first jaw and the second jaw being movable between an engaged position and a disengaged position; and a locking mechanism configured to secure the first jaw and the second jaw in the engaged position, the locking mechanism comprising: a shaft extending at least partially through at least one of the first jaw and the second jaw; and a handle mechanism coupled to the shaft, the handle mechanism configured to translate the shaft in a lateral direction such that the shaft contacts at least one of the first jaw and the second jaw in the engaged position.

Aspect 2. The zipper stopper of aspect 1, wherein the first jaw includes a slide bar extending from a first jaw proximal end of the first jaw.

Aspect 3. The zipper stopper of aspect 1 or 2, wherein the second jaw includes a slide bar guide formed in a second jaw proximal end of the second jaw.

Aspect 4. The zipper stopper of any of aspects 1-3, wherein the slide bar of the first jaw is received within the slide bar guide of the second jaw when the first jaw and the second jaw are in the engaged position.

Aspect 5. The zipper stopper of any of aspects 1-4, wherein the shaft of the locking mechanism extends at least partially through the second jaw and contacts the slide bar of the first jaw when the first jaw and the second jaw are in the engaged position.

Aspect 6. The zipper stopper of aspect 1, wherein the first jaw and the second jaw are inextricably coupled.

Aspect 7. The zipper stopper of aspect 1, wherein at least one of the first jaw or the second jaw further includes a chain engagement feature that protrudes from at least one of the first jaw or the second jaw.

Aspect 8. The zipper stopper of aspect 2, wherein the slide bar further includes a slide bar hole that receives the shaft of the locking mechanism when the first jaw and the second jaw are in the engaged position.

Aspect 9. The zipper stopper of aspect 1, further comprising a spring system configured to move the first jaw and the second jaw between the engaged position and the disengaged position.

Aspect 10. The zipper stopper of aspect 1, further comprising a living hinge coupled to each of the first jaw and the second jaw, the living hinge being configured to move the first jaw and the second jaw between the engaged position and the disengaged position.

Aspect 11. A zipper slider locking system comprising: a zipper chain; a zipper slider coupled to the zipper chain, such that the zipper slider is configured to translate along the zipper chain in a longitudinal direction; and a zipper stopper releasably secured about the zipper chain and further comprising: a pair of opposing jaws including at least a first jaw and a second jaw opposing the first jaw, the first jaw and the second jaw being movable between an engaged position and a disengaged position; and a locking mechanism configured to secure the first jaw and the second jaw in the engaged position, the locking mechanism comprising: a shaft extending at least partially through at least one of the first jaw and the second jaw; and a handle mechanism coupled to the shaft, the handle mechanism configured to translate the shaft in a lateral direction such that the shaft contacts at least one of the first jaw and the second jaw in the engaged position; wherein the zipper stopper limits translation of the zipper slider in the longitudinal direction when the first jaw and the second jaw are in the engaged position.

Aspect 12. The zipper slider locking system of aspect 11, wherein the first jaw includes a slide bar extending from a first jaw proximal end of the first jaw.

Aspect 13. The zipper slider locking system of aspect 11 or 12, wherein the second jaw includes a slide bar guide formed in a second jaw proximal end of the second jaw.

Aspect 14. The zipper slider locking system of any of aspects 11-13, wherein the slide bar of the first jaw is received within the slide bar guide of the second jaw when the first jaw and the second jaw are in the engaged position.

Aspect 15. The zipper slider locking system of any of aspects 11-14, wherein the shaft of the locking mechanism extends at least partially through the second jaw and contacts the slide bar of the first jaw when the first jaw and the second jaw are in the engaged position.

Aspect 16. The zipper slider locking system of any of aspects 11-15, wherein at least one of the first jaw or the second jaw further includes a chain engagement feature that protrudes from at least one of the first jaw or the second jaw.

Aspect 17. The zipper slider locking system of any of aspects 11-16, wherein the chain engagement feature extends between at least a pair of a plurality of teeth of the zipper chain when the first jaw and the second jaw are in the compressed position.

Aspect 18. The zipper slider locking system of any of aspects 11-16, wherein the slide bar further includes a slide bar hole that receives the shaft of the locking mechanism when the first jaw and the second jaw are in the engaged position.

Aspect 19. The zipper slider locking system of any of aspects 11-18, wherein the first jaw and the second jaw apply a compressive force on the zipper chain when the first jaw and the second jaw are in the engaged position.

Aspect 20. A method of locking a zipper slider, the method comprising: translating the zipper slider to a desired location along a zipper chain; positioning a first jaw and a second jaw of a zipper stopper in a disengaged position, such that the first jaw is released from the second jaw; positioning the first jaw and the second jaw of the zipper stopper about the zipper chain adjacent the zipper slider; engaging the first jaw and the second jaw of the zipper stopper, such that the first jaw and the second jaw are moved to an engaged position; and releasably securing the first jaw to the second jaw using a locking mechanism of the zipper stopper.

Aspect 21. A zipper stopper comprising a pair of opposing jaws including at least a first jaw and a second jaw opposing the first jaw, the first jaw and the second jaw being integrally formed, wherein the first jaw and the second jaw are elastically deformable between an engaged position and a disengaged position.

Aspect 22. The zipper stopper of aspect 21, wherein a first jaw pad is affixed to a first end of the first jaw and a second jaw pad is affixed to a first end of the second jaw.

Aspect 23. A zipper slider locking system comprising: a zipper chain; a zipper slider coupled to the zipper chain, such that the zipper slider is configured to translate along the zipper chain in a longitudinal direction; and a zipper stopper releasably secured about the zipper chain and further comprising: a pair of opposing jaws including at least a first jaw and a second jaw opposing the first jaw, the first jaw and the second jaw being integrally formed, wherein the first jaw and the second jaw are elastically deformable between an engaged position and a disengaged position and the zipper stopper limits translation of the zipper slider in the longitudinal direction when the first jaw and the second jaw are in the engaged position.

Aspect 24. The zipper slider locking system of aspect 23, wherein a first jaw pad is affixed to a first end of the first jaw and a second jaw pad is affixed to a first end of the second jaw.

Aspect 25. A zipper stopper comprising: a pair of opposing jaws including at least a first jaw and a second jaw opposing the first jaw, the first jaw and the second jaw being movable between an engaged position and a disengaged position; a housing coupled to the first jaw and the second jaw, the housing including a plurality of housing teeth; a locking mechanism configured to secure the first jaw and the second jaw in the engaged position, the locking mechanism comprising: a gear having a plurality of gear teeth translatably coupled to the plurality of housing teeth, such that rotation of the gear of the locking mechanism translates the first jaw and the second jaw between the engaged position and the disengaged position.

Aspect 26. The zipper stopper of aspect 25, wherein the locking mechanism further includes a pawl tab translatable between a locked position and an unlocked position, such that the first jaw and the second jaw are fixed in either the engaged position or the disengaged position when the pawl tab is in the locked position.

Aspect 27. The zipper stopper of aspect 25 or 26, wherein the pawl tab engages the plurality of housing teeth to prevent translation of the gear when the pawl tab is in the locked position.

Aspect 28. A zipper stopper comprising: a pair of opposing jaws including at least a first jaw and a second jaw opposing the first jaw, the first jaw and the second jaw being movable between an engaged position and a disengaged position; a pair of arms including a first arm and a second arm, the first arm and the second arm each extending between and coupled to the first jaw and the second jaw and being movable between an extended position and a compressed position; and a screw extending between the first arm and the second arm; wherein rotation of the screw translates the first arm and the second arm between the compressed position and the extended position, such that the first jaw and second jaw move from the engaged position to the disengaged position.

Aspect 29. A zipper stopper comprising: a first jaw coupled to a casing; and a second jaw coupled to a tube, the second jaw opposing the first jaw; wherein the first jaw and the second jaw are movable between an engaged position and a disengaged position, such that, in the engaged position, the tube coupled to the second jaw is received by the casing coupled to the first jaw.

Aspect 30. The zipper stopper of aspect 29, further comprising a casing retainer disposed within the casing coupled to the first jaw and a tube retainer disposed about the tube coupled to the second jaw, wherein the casing retainer engages the tuber retainer when the first jaw and the second jaw are in the engaged position.

Aspect 31. The zipper stopper of aspect 1, wherein the shaft is a threaded shaft, such that rotation of the shaft translates the shaft in the lateral direction.

Aspect 32. The zipper slider locking system of any of aspects 11-17, wherein the shaft is a threaded shaft, such that rotation of the shaft translates the shaft in the lateral direction.

Aspect 33. The zipper slider locking system of any of aspects 11-18, further comprising a zipper pull tab secured to the zipper slider for translating the zipper slider in the longitudinal direction.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A zipper stopper comprising:
a pair of opposing jaws including at least a first jaw and a second jaw opposing the first jaw, the first jaw and the second jaw being movable between an engaged position and a disengaged position; and
a locking mechanism configured to secure the first jaw and the second jaw in the engaged position, the locking mechanism comprising:
a shaft extending at least partially through at least one of the first jaw and the second jaw; and
a handle mechanism coupled to the shaft, the handle mechanism configured to translate the shaft in a lateral direction such that the shaft contacts at least one of the first jaw and the second jaw in the engaged position.

2. The zipper stopper of claim 1, wherein the first jaw includes a slide bar extending from a first jaw proximal end of the first jaw.

3. The zipper stopper of claim 2, wherein the second jaw includes a slide bar guide formed in a second jaw proximal end of the second jaw.

4. The zipper stopper of claim 3, wherein the slide bar of the first jaw is received within the slide bar guide of the second jaw when the first jaw and the second jaw are in the engaged position.

5. The zipper stopper of claim 3, wherein the shaft of the locking mechanism extends at least partially through the second jaw and contacts the slide bar of the first jaw when the first jaw and the second jaw are in the engaged position.

6. The zipper stopper of claim 1, wherein the first jaw and the second jaw are inextricably coupled.

7. The zipper stopper of claim 1, wherein at least one of the first jaw or the second jaw further includes a chain engagement feature that protrudes from at least one of the first jaw or the second jaw.

8. The zipper stopper of claim 2, wherein the slide bar further includes a slide bar hole that receives the shaft of the locking mechanism when the first jaw and the second jaw are in the engaged position.

9. The zipper stopper of claim 1, further comprising a spring system configured to move the first jaw and the second jaw between the engaged position and the disengaged position.

10. The zipper stopper of claim 1, further comprising a living hinge coupled to each of the first jaw and the second jaw, the living hinge being configured to move the first jaw and the second jaw between the engaged position and the disengaged position.

11. A zipper slider locking system comprising:
a zipper chain;
a zipper slider coupled to the zipper chain, such that the zipper slider is configured to translate along the zipper chain in a longitudinal direction; and
a zipper stopper releasably secured about the zipper chain and further comprising:
a pair of opposing jaws including at least a first jaw and a second jaw opposing the first jaw, the first jaw and the second jaw being movable between an engaged position and a disengaged position; and
a locking mechanism configured to secure the first jaw and the second jaw in the engaged position, the locking mechanism comprising:
a shaft extending at least partially through at least one of the first jaw and the second jaw; and
a handle mechanism coupled to the shaft, the handle mechanism configured to translate the shaft in a lateral direction such that the shaft contacts at least one of the first jaw and the second jaw in the engaged position;
wherein the zipper stopper limits translation of the zipper slider in the longitudinal direction when the first jaw and the second jaw are in the engaged position.

12. The zipper slider locking system of claim 11, wherein the first jaw includes a slide bar extending from a first jaw proximal end of the first jaw.

13. The zipper slider locking system of claim 12, wherein the second jaw includes a slide bar guide formed in a second jaw proximal end of the second jaw.

14. The zipper slider locking system of claim 13, wherein the slide bar of the first jaw is received within the slide bar guide of the second jaw when the first jaw and the second jaw are in the engaged position.

15. The zipper slider locking system of claim 13, wherein the shaft of the locking mechanism extends at least partially through the second jaw and contacts the slide bar of the first jaw when the first jaw and the second jaw are in the engaged position.

16. The zipper slider locking system of claim 11, wherein at least one of the first jaw or the second jaw further includes a chain engagement feature that protrudes from at least one of the first jaw or the second jaw.

17. The zipper slider locking system of claim 16, wherein the chain engagement feature extends between at least a pair of a plurality of teeth of the zipper chain when the first jaw and the second jaw are in the engaged position.

18. The zipper slider locking system of claim 12, wherein the slide bar further includes a slide bar hole that receives the shaft of the locking mechanism when the first jaw and the second jaw are in the engaged position.

19. The zipper slider locking system of claim 11, wherein the first jaw and the second jaw apply a compressive force on the zipper chain when the first jaw and the second jaw are in the engaged position.

20. (canceled)

21. A zipper stopper comprising:
a pair of opposing jaws including at least a first jaw and a second jaw opposing the first jaw, the first jaw and the second jaw being movable between an engaged position and a disengaged position;
a casing frame defined within the first jaw;
a tube integrally formed with and extending from the second jaw, the tube being configured to be received within the casing frame defined within the first jaw; and
a spring system disposed between the casing frame and the tube, such that the spring system extends about the tube when the first jaw and the second jaw are moved to the engaged position.
